(19) United States
(12) Patent Application Publication
(10) Pub. No.: US 2025/0085099 A1
(43) Pub. Date: Mar. 13, 2025

(54) DETERMINING ELECTROMAGNETIC WAVE CONTROL FOR MATTER-WAVE INTERFEROMETRY

(71) Applicant: ColdQuanta, Inc., Boulder, CO (US)

(72) Inventors: Lennart Maximilian Seifert, Chicago, IL (US); Michael Alexandrovich Perlin, Chicago, IL (US); Victor Colussi, Boulder, CO (US)

(73) Assignee: ColdQuanta, Inc., Boulder, CO (US)

(21) Appl. No.: 18/822,945

(22) Filed: Sep. 3, 2024

Related U.S. Application Data
(60) Provisional application No. 63/536,757, filed on Sep. 6, 2023.

(51) Int. Cl. G01B 9/02001; G01B 9/02015; G01B 9/02055

(52) U.S. Cl. CPC G01B 9/02001; G01B 9/0203; G01B 9/02069; G01B 2290/55

(57) ABSTRACT

During one or more active periods of time over which at least one of an amplitude, frequency, or phase of one or more optical wave(s) are modified, the optical wave(s) overlap with and interact with a gaseous cloud of IAMs and transfer portions of the among different distributions of momentum states. Control signals for controlling aspects of the optical wave(s) are determined based at least in part on (1) a constraint determined based at least in part on a set of optical wave parameters, and a set of quantum state parameters, where two or more of the quantum state parameters do not satisfy the constraint, and/or (2) a partial derivative of one or more quantum states associated with the IAMs, where the partial derivative is with respect to an optimization parameter determined based at least in part on the one or more optical waves or the estimation parameter.

### CROSS-REFERENCE TO RELATED APPLICATION(S)

This application claims priority to and the benefit of U.S. Provisional Application Ser. No. 63/536,757, entitled “DETERMINING ELECTROMAGNETIC WAVE CONTROL FOR MATTER-WAVE INTERFEROMETRY,” filed Sep. 6, 2023, which is incorporated herein by reference.

### TECHNICAL FIELD

This disclosure relates to determining electromagnetic wave control for matter-wave interferometry.

### BACKGROUND

An optical Mach-Zehnder interferometer can measure a phase shift between two optical beams and thereby estimate a parameter associated with the measured phase shift. For example, if one of the beams traverses a path length that varies as a function of time, then the measured phase shift may correspondingly vary in time and provide information associated with the change in path length. In contrast to optical interferometry, where such parameter estimation is based on the interference of two light waves, matter-wave interferometry (e.g., atom interferometry) can perform parameter estimation based on the interference of two matter waves (e.g., associated with the quantum states of ions, atoms, or molecules). Matter-wave interferometers may be operated by the application of electromagnetic waves to the ions, atoms, or molecules.

### SUMMARY

In one aspect, in general, an apparatus comprises: a housing configured to provide a low-pressure environment; a gaseous cloud of ions, atoms, or molecules (IAMs) located in the housing and characterized by a first distribution of momentum states; a laser configured to emit one or more optical waves; a memory storing information associated with a set of control signals for controlling at least one of an intensity, frequency, phase, start time, or duration of the one or more optical waves emitted by the laser; one or more control modules configured to control at least one of the intensity, frequency, phase, start time, or duration of the one or more optical waves emitted by the laser based at least in part on the set of control signals; at least one photodetector configured to measure a measurement signal associated with a final distribution of momentum states of the IAMs; and a computing device comprising one or more processors in communication with the photodetector and configured to estimate an estimation parameter associated with the IAMs; where, during one or more active periods of time over which at least one of an amplitude, frequency, or phase of the one or more optical waves emitted by the laser are modified, the one or more optical waves overlap with and interact with the IAMs and transfer a first portion of the IAMs from the first distribution of momentum states to a second distribution of momentum states, and transfer a second portion of the IAMs from the second distribution of momentum states to a third distribution of momentum states; where the set of control signals are determined based at least in part on at least one of (1) a constraint determined based at least in part on a set of optical wave parameters associated with the one or more optical waves, and a set of quantum state parameters that are associated with one or more quantum states of the IAMs, where two or more of the quantum state parameters do not satisfy the constraint, or (2) a partial derivative of one or more quantum states associated with the IAMs, where the partial derivative is with respect to an optimization parameter determined based at least in part on the one or more optical waves or the estimation parameter.

Aspects can include one or more of the following features.

The set of control signals are further determined based at least in part on one or more free evolution periods of time over which at least one of the amplitude, frequency, or phase of the one or more optical waves emitted by the laser are not modified.

At least one of the one or more free evolution periods of time is at least twice as long in duration as at least one of the one or more active periods of time.

The set of control signals are further determined based at least in part on one or more matrices associated with the IAMs during the one or more free evolution periods.

The set of quantum state parameters comprises a first quantum state parameter and a second quantum state parameter that are associated with different times during one of the one or more free evolution periods of time and satisfy the constraint.

The second quantum state parameter is equal to a multiplication product of (1) the first quantum state parameter and (2) at least one of the one or more matrices.

The one or more optical waves form one or more standing waves at the location of the gaseous cloud.

The one or more optical waves form two or more standing waves at the location of the gaseous cloud and the estimation parameter is associated with at least one angular acceleration or at least two different directions of acceleration.

The estimation parameter is associated with acceleration.

Each of the first, second, third, and final distributions of momentum states comprises a plurality of population quantities each corresponding to a different respective momentum state of a plurality of momentum states.

The second distribution of momentum states comprises a first population quantity of a corresponding momentum state characterized by zero momentum and the third distribution of momentum states comprises a second population quantity of a corresponding momentum state characterized by zero momentum, and where the second population quantity is larger than the first population quantity.

During the one or more active periods of time, the one or more optical waves further overlap and interact with the IAMs and transfer a third portion of the IAMs from the third distribution of momentum states to a fourth distribution of momentum states comprising a third population quantity of a corresponding momentum state characterized by zero momentum, where the second population quantity is larger than the third population quantity.

The final distribution of momentum states is equal to the fourth distribution of momentum states.

The set of control signals are further determined based at least in part on classical Fisher information associated with (1) the final distribution of momentum states and (2) the one or more optical waves or the estimation parameter.

The final distribution of momentum states is equal to the third distribution of momentum states.

In another aspect, in general, a method for performing matter-wave interferometry comprises: determining control signals for one or more optical waves emitted by a laser that interact with a gaseous cloud of ions, atoms, or molecules (IAMs) characterized by a first distribution of momentum states; controlling at least one of an intensity, frequency, phase, start time, or duration of the one or more optical waves, based at least in part on the determined control signals; measuring a measurement signal associated with a distribution of momentum states of the gaseous cloud; estimating an estimation parameter associated with the IAMs based at least in part on the measurement signal; where, during one or more active periods of time over which at least one of an amplitude, frequency, or phase of the one or more optical waves emitted by the laser are modified, the one or more optical waves overlap with and interact with the IAMs and transfer a first portion of the IAMs from the first distribution of momentum states to a second distribution of momentum states, and transfer a second portion of the IAMs from the second distribution of momentum states to a third distribution of momentum states; where determining the control signals comprises (1) determining a constraint based at least in part on a set of optical wave parameters associated with the one or more optical waves, and a set of quantum state parameters that are associated with one or more quantum states of the IAMs, where the quantum state parameters do not satisfy the constraint during candidate active periods of time over which at least one of the amplitude, frequency, or phase of the one or more optical waves emitted by the laser are modified, or (2) determining a partial derivative of one or more quantum states associated with the IAMs, where the partial derivative is with respect to an optimization parameter determined based at least in part on the one or more optical waves or the estimation parameter.

Aspects can include one or more of the following features.

Determining the control signals is further based at least in part on one or more free evolution periods of time over which at least one of the amplitude, frequency, or phase of the one or more optical waves emitted by the laser are not modified.

At least one of the one or more free evolution periods of time is at least twice as long in duration as at least one of the one or more active periods of time.

Determining the control signals is further based at least in part on one or more matrices associated with the IAMs during the one or more free evolution periods.

The set of quantum state parameters comprises a first quantum state parameter and a second quantum state parameter that are associated with different times during one of the one or more free evolution periods of time and satisfy the constraint.

The second quantum state parameter is equal to a multiplication product of (1) the first quantum state parameter and (2) at least one of the one or more matrices.

The one or more optical waves form one or more standing waves at the location of the gaseous cloud.

The one or more optical waves form two or more standing waves at the location of the gaseous cloud and the estimation parameter is associated with at least one angular acceleration or at least two different directions of acceleration.

The estimation parameter is associated with acceleration.

Each of the first, second, third, and final distributions of momentum states comprises a plurality of population quantities each corresponding to a different respective momentum state of a plurality of momentum states.

The second distribution of momentum states comprises a first population quantity of a corresponding momentum state characterized by zero momentum and the third distribution of momentum states comprises a second population quantity of a corresponding momentum state characterized by zero momentum, and where the second population quantity is larger than the first population quantity.

During the one or more active periods of time, the one or more optical waves further overlap and interact with the IAMs and transfer a third portion of the IAMs from the third distribution of momentum states to a fourth distribution of momentum states comprising a third population quantity of a corresponding momentum state characterized by zero momentum, where the second population quantity is larger than the third population quantity.

The final distribution of momentum states is equal to the fourth distribution of momentum states.

Determining the control signals is further based at least in part on classical Fisher information associated with (1) the final distribution of momentum states and (2) the one or more optical waves or the estimation parameter.

The final distribution of momentum states is equal to the third distribution of momentum states.

Aspects can have one or more of the following advantages.

The subject matter disclosed herein can be implemented in the context of matter-wave interferometry to design shaking sequences (e.g., where light emitted from a laser has its amplitude, frequency, or phase modified) that can increase the population of quantum states associated with larger momentum. End-to-end optimization methods and direct collocation methods, or the combination of both, may be used to design shaking sequences that result in a matter-wave interferometer that is more sensitive to one or more parameters that are to be measured. Physically motivated constraints and initial conditions may also be applied as so to construct optimization methods that enhance performance of matter-wave interferometers. In some examples disclosed herein, one or more periods of free propagation (i.e., where light emitted from the laser does not have its amplitude, frequency, or phase modified), also referred to as free evolution periods of time, allow for precomputing of quantum propagators over the free propagation times, thus leading to significantly reduced computational cost during the optimization and increased accuracy in parameter estimation.

Other features and advantages will become apparent from the following description, and from the figures and claims.

More detailed explanations, and other advantages, are described in the attached Appendices.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic diagram of an example matter-wave interferometer.

FIG. 2 is a schematic diagram of an example optical configuration.

FIG. 3 is a schematic diagram of an example optical configuration.

FIG. 4A is a schematic diagram of an example PICO method in the context of quantum optimal control.

FIG. 4B is a schematic diagram of an example PICO method in the context of quantum optimal control.

FIG. 5A is a prophetic plot of the time evolution of Bloch states of IAMs during execution of an example shaking protocol.

FIG. 5B is a prophetic plot of the time evolution of Bloch states of IAMs during execution of an example shaking protocol.

FIG. 6 includes eight prophetic plots of the relative population in each momentum state for eight different Bloch states.

FIG. 7 is a prophetic plot of the time evolution of Bloch states of IAMs during execution of an example shaking protocol.

FIG. 8 is a prophetic plot of the time evolution of Bloch states of IAMs during execution of an example shaking protocol.

FIG. 9A is a prophetic plot of a convergence history of an objective value associated with an example objective function for an atom mirror operation, as a function of time, for two different optimization configurations.

FIG. 9B a prophetic plot of the norm of the step taken to update the optimization variables in each iteration during an example optimization method for an atom mirror operation, for the same two optimization configurations of FIG. 9A.

FIG. 9C is a prophetic plot of the time evolution of Bloch states of IAMs during execution of an example shaking protocol.

FIG. 9D is a prophetic plot of the time evolution of Bloch states of IAMs during execution of an example shaking protocol.

FIG. 10A is a prophetic plot of the time evolution of Bloch states of IAMs during execution of an example shaking protocol.

FIG. 10B is a prophetic plot of the time evolution of Bloch states of IAMs during execution of an example shaking protocol.

### DETAILED DESCRIPTION

Some electromagnetic waves have a spectrum that has a peak wavelength that falls in a particular range of optical wavelengths (e.g., between about 100 nm to about 1 mm, or some subrange thereof), also referred to as optical waves, light waves, or simply light.

A matter-wave interferometer (e.g., configured as an accelerometer) can be realized by trapping a gaseous cloud of ions, atoms, or molecules (IAMs) in one or more standing waves of light (also referred to as optical lattices) that interact with the gaseous cloud of IAMs, followed by one or more laser sequences designed to apply a shaking protocol to modify (e.g., spatially translate) the trapping potential provided by the optical lattices and thus modify one or more quantum states associated with the IAMs. The evolution of the IAMs' quantum states can depend at least in part on external perturbations (e.g., acceleration, angular acceleration, and gravitational fields) and the specific shaking protocol can modify the sensitivity of the quantum state of the IAMs to such perturbations. For example, constructing a high-performing accelerometer can be achieved by designing a shaking protocol comprising one or more laser sequences to enhance or possibly maximize the sensitivity of the IAMs to accelerations.

The procedure for designing such shaking protocols can be challenging and may utilize optimization methods that include quantum optimal control, where desired quantum dynamics can be achieved by tailored laser sequences, and machine-learning techniques (e.g., reinforcement learning). The subject matter disclosed herein includes quantum optimal control methods based on direct collocation that allow for improved parameter sensitivity (e.g., sensitivity to acceleration). In some examples the matter-wave interferometer is configured as an accelerometer in one dimension, however the methods disclosed herein can be used to sense accelerations in two or three dimensions, or one or more angular accelerations.

One example approach to designing a shaking protocol is based on the paradigm of Mach-Zehnder (MZ) interferometry. To begin, a trapping potential (e.g., from an optical lattice) is shaken such that a gaseous cloud of IAMs splits into two equal components (analogous to a “beam splitting” operation) that travel apart from one another with equal and opposite momenta. After a fixed free propagation time (i.e., no active shaking is applied to the IAMs), a shaking sequence inverts the momenta of the two components (analogous to a “mirror” operation), thus directing the two components to move toward each other. After the same free propagation time, a shaking sequence that is the time-reversed sequence of the splitting operation can be applied to recombine the two components, thus concluding the shaking protocol and the interrogation of the IAMs.

In general, the sensitivity of a matter-wave interferometer can depend on the magnitude of the momentum splitting and the free propagation time. In some examples, the desired momentum splitting may be fixed and shaking sequences for splitting and mirroring can be designed to achieve the desired momentum splitting. Realizing higher momentum splittings may increase the sensitivity of a matter-wave interferometer, however higher momentum splittings are increasingly more challenging to achieve since the complexity of their optimization increases rapidly. As an example, reinforcement learning approaches may struggle to find satisfactory solutions for higher momentum splittings, since such approaches may explore a limited set of actions that may need to be predefined by the user.

In some examples, the Mach-Zehnder paradigm is not strictly followed. For example, the shaking protocol comprising one or more shaking sequences (e.g., laser sequences) may instead be directly optimized for a parameter (e.g., sensitivity to acceleration) over the entire interrogation time in an end-to-end fashion. Such end-to-end optimization is distinct from the Mach-Zehnder paradigm, where the shaking operations are constrained to perform a set of predefined operations (e.g., splitting, mirroring, or recombining). End-to-end optimization methods may in some examples be configured to optimize (e.g., maximize or minimize) a metric that correlates to the sensitivity of the matter-wave interferometer, such as the classical Fisher information of the final distribution of momentum states of the gaseous cloud of IAMs with respect to a parameter (e.g., acceleration). End-to-end optimization methods may be configured to optimize (e.g., maximize or minimize) a metric that correlates to the robustness of the matter-wave interferometer (e.g., with respect to fluctuations), such as the classical Fisher information of the final distribution of momentum states of the gaseous cloud of IAMs with respect to changes in the depth of the optical trapping potential (e.g., due to fluctuations in the laser) that may occur during the shaking protocol. Directly applying standard quantum optimal control methods in the context of end-to-end optimization can be computationally expensive since it may require finely discretizing the quantum state evolution over a large total interrogation time. The subject matter disclosed herein may overcome such challenges by implementing direct collocation optimal control methods with additional structure (e.g., objectives, constraints, initial conditions, and extended periods of free propagation) to perform end-to-end optimization.

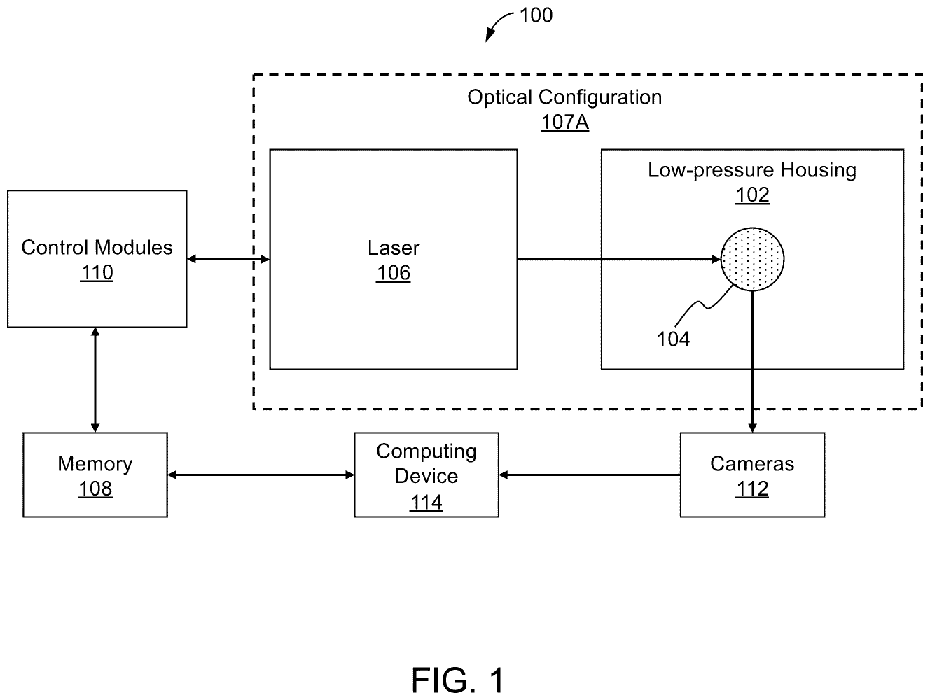

FIG. 1 shows an example matter-wave interferometer 100 comprising a low-pressure housing 102 configured to provide a low-pressure environment (e.g., characterized by a pressure less than 100 micro pascals). A gaseous cloud of IAMs 104 (ions, atoms, or molecules) are located within the low-pressure housing 102 and are characterized by a first distribution of momentum states (e.g., with a majority of population in a zero-momentum state). In some examples, the gaseous cloud of IAMs 104 is a Bose-Einstein condensate (BEC). A laser 106 is configured to emit one or more optical waves that enter into the low-pressure housing 102 and interact with the gaseous cloud of IAMs 104. The low-pressure housing, the gaseous cloud of IAMs 104, and the laser 106 together comprise a first example optical configuration 107A configured to form one or more standing waves at the location of the gaseous cloud of IAMs 104. A memory 108, in communication with one or more control modules 110, is configured to store information associated with a set of control signals for controlling at least one of an intensity, frequency, phase, start time, or duration of the one or more optical waves emitted by the laser 106. The control modules 110 are in communication with the laser 106 and are configured to control at least one of the intensity, frequency, phase, start time, or duration of the one or more optical waves emitted by the laser 106 based at least in part on the set of control signals. One or more cameras 112 (e.g., comprising one or more photodetectors) are configured to measure a measurement signal associated with a final distribution of momentum states of the gaseous cloud of IAMs 104 after the shaking protocol. In some examples, the cameras 112 is a single camera that captures spatial intensity information associated with the spatial density of the gaseous cloud of IAMs 104.

Referring again to FIG. 1, in some examples, an imaging laser (not shown) can emit optical waves that scatter off of the gaseous cloud of IAMs 104, where the amount of scattering depends on the local densities within the gaseous cloud of IAMs 104, such that unscattered light then impinges on the cameras 112. In such examples, the unscattered light that impinges on the cameras 112 provides information associated with the spatial density of the gaseous cloud of IAMs 104. The matter-wave interferometer 100 further comprises a computing device 114, comprising one or more processors, in communication with the cameras 112 and configured to estimate an estimation parameter associated with the gaseous cloud of IAMs 104 (e.g., an acceleration or an angular acceleration). The one or more optical waves emitted by the laser 106, during one or more active periods of time over which at least one of an amplitude, frequency, or phase of the one or more optical waves emitted by the laser 106 are modified, can overlap and interact with the IAMS 104 and transfer a first portion of the IAMs 104 from the first distribution of momentum states to a second distribution of momentum states, and can overlap and interact with the IAMs 104 and transfer a second portion of the IAMs 104 from the second distribution of momentum states to a third distribution of momentum states. In some examples, the set of control signals are determined based at least in part on at least one of (1) a constraint determined based at least in part on a set of optical wave parameters associated with the one or more optical waves, and a set of quantum state parameters that are associated with one or more quantum states of the IAMs 104, where two or more of the quantum state parameters do not satisfy the constraint, or (2) a partial derivative of one or more quantum states associated with the IAMs 104, where the partial derivative is with respect to an optimization parameter determined based at least in part on the one or more optical waves or the estimation parameter.

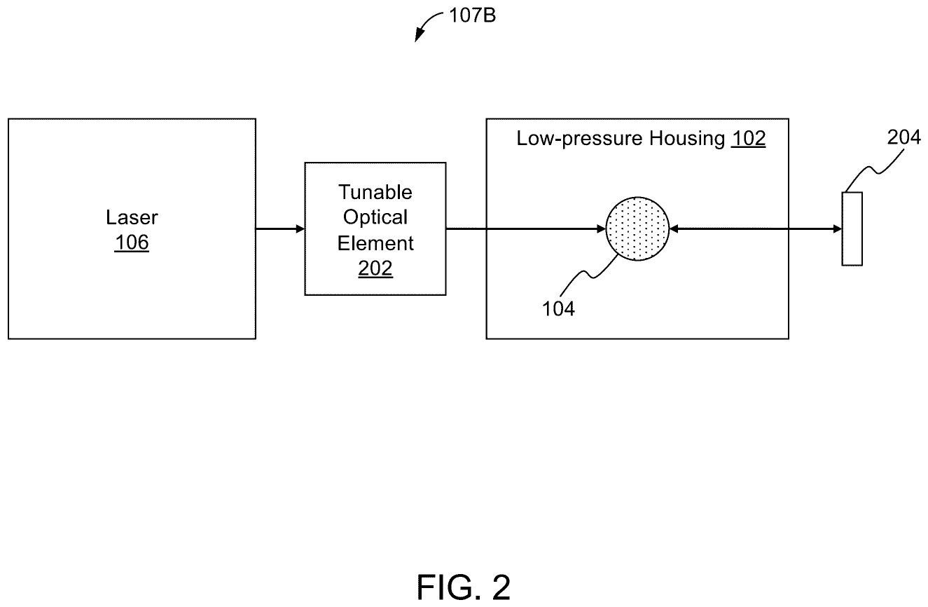

FIG. 2 shows a second example optical configuration 107B that is a more detailed example embodiment of the first example optical configuration 107A of FIG. 1. The second example optical configuration 107B comprises a tunable optical element 202 located between the laser 106 and the low-pressure housing 102 and that tunes the amplitude, frequency, phase, start time, or duration of optical waves emitted by the laser 106. A mirror 204 reflects the optical waves after they traverse through the gaseous cloud of IAMs 104, redirecting the optical waves to again traverse through the gaseous cloud of IAMs 104 and to thus form a standing wave. In general, a standing wave of light is formed when two travelling optical waves overlap, have a similar frequency, and have a portion of their direction of propagation that is opposite to the direction of propagation of the other travelling optical wave. In some examples, the tunable optical element 202 is an acousto-optic modulator (AOM) that can direct the optical waves to the gaseous cloud of IAMs 104 based at least in part on a radio frequency (RF) voltage applied to the AOM, thus allowing for control over the start time and duration of the optical waves. Furthermore, the AOM can modify the frequency of the optical waves based at least in part on the frequency of the RF voltage applied to the AOM. The amplitude of the RF voltage applied to the AOM also enables control over the intensity of the optical waves directed towards the gaseous cloud of IAMs 104. In some examples, the tunable optical element 202 is an electro-optic modulator (EOM) that can add sidebands to the optical waves (i.e., add additional frequency components to the optical waves) and can modify the phase of the optical waves. By modifying the intensity, frequency or phase of the optical waves, the standing wave pattern formed at the gaseous cloud of IAMs 104 changes, resulting in a shaking motion being applied to the IAMs 104.

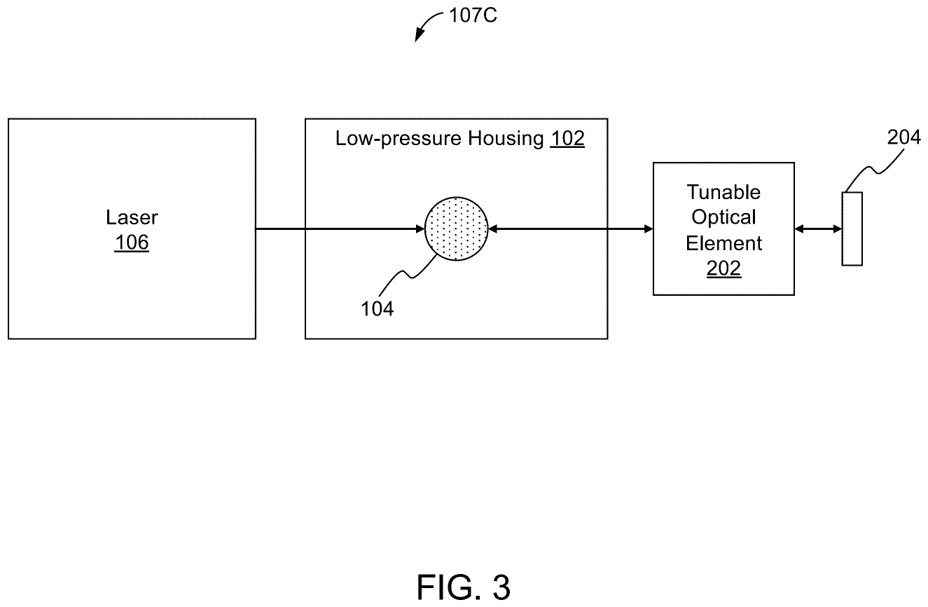

FIG. 3A shows a third example optical configuration 107C that is a more detailed example embodiment of the first example optical configuration 107A of FIG. 1. In this example, a tunable optical element 202 is located between a low-pressure housing 102 and a mirror 204. The tunable optical element 202 modifies the optical waves that are reflected back to the gaseous cloud of IAMs 104. Since the standing wave pattern formed at the gaseous cloud of IAMs 104 depends on optical waves that are provided from both the laser 106 and optical waves reflected from the mirror 204, the tunable optical element 202 can also modify the standing wave pattern formed at the gaseous cloud of IAMs 104, resulting in a shaking motion being applied to the IAMs 104.

FIG. 3B shows a fourth example optical configuration 107D that is a more detailed example embodiment of the first example optical configuration 107A of FIG. 1. In this example, a tunable optical element 202 is located between a low-pressure housing 102 and a second path of light 302. The tunable optical element 202 modifies optical waves that are transmitted along the second path of light 302 to the gaseous cloud of IAMs 104. In some examples, the second path of light 302 can be generated by placing a beam splitter in the path of light emitted by the laser 106.

Referring to the first example optical configuration 107A of FIG. 1, the second example optical configuration 107B of FIG. 2, the third example optical configuration 107C of FIG. 3A, and the fourth example optical configuration 107D of FIG. 3B, the laser 106 in each example may be able to tune, in response to control signals sent from control modules (e.g., the control modules 110 of FIG. 1) the intensity, frequency, phase, start time, and/or duration of the one or more optical waves it emits. In such examples, the tunable optical elements 202 of FIGS. 2,3A, and 3B may provide additional tunability or may be absent.

In some examples, optimization methods may be used to determine shaking protocols that are utilized to perform matter-wave interferometry. For example, direct trajectory optimization methods seek to find a trajectory (i.e., a sequence of values for one or more variables) that minimizes (or maximizes) some metric associated with performance (e.g., sensitivity to acceleration) while satisfying a set of constraints (e.g., the laws of physics). In some trajectory optimization problems, variables may be classified as state variables (e.g., a quantum state) and control variables (e.g., the intensity, frequency or phase of a laser).

Indirect optimization methods (i.e., not direct trajectory optimization methods) may optimize over the space of possible control variables, and the values of these control variables in turn determine the value of the state variables (e.g., by simulating the Schrödinger equation). The dynamical constraints of the problem (e.g., the laws of physics) are often then forced, by construction, to be obeyed at all times, thus ensuring feasibility (i.e., physically allowed solutions) in each iteration.

In contrast, direct trajectory optimization methods may optimize over the space of all possible control and state variables. The dynamical constraints (e.g., the Schrödinger equation) can be treated as constraints for the optimizer, such that final solutions to the optimization problem converge to satisfy these constraints, but intermediate solutions during optimization may not necessarily satisfy the constraints. Direct collocation methods are a subset of direct trajectory optimization methods that can directly discretize the state trajectory and control trajectory (i.e., the values of the state variables and the values of the control variables as a function of time) and can solve a large nonlinear optimization problem for both trajectories. An advantage that direct collocation methods can provide over indirect optimization methods is additional flexibility during optimization that can thereby enhance the end result of the optimization. The additional flexibility occurs because, in contrast to indirect optimization methods, direct collocation methods can temporarily explore quantum state trajectories that are not physically possible, but can ultimately converge to physically possible quantum state trajectories due to enforcement of constraints. In general, direct collocation methods differ in how system dynamics are enforced (i.e., how physically feasible solutions are enforced).

PICO (Pade Integrator Collocation) methods are an example of a direct collocation method that enforces the dynamics of the controlled system through constraints between knot points (e.g., between different moments in discretized time). In some examples, the subject matter disclosed herein implements constraints at specific moments of discretized time to mimic jumps in the quantum evolution. PICO methods allow for the customization of the Schrödinger-based constraints on quantum state evolution, thereby allowing the optimization method to replace the default integration steps (e.g., e^{-iHdt} for small dt and where H is a Hamiltonian matrix) with other unitary operators that connect the quantum state at time step t and t+1. PICO methods can be used to approximate dynamics (e.g., governed by the matrix exponential e^{-iHdt}) by using the Pade approximation. The Pade approximation of a function near a specific point is given by a rational function of a given order.

In some example implementations of indirect optimization methods, the Schrödinger equation is integrated over a shaking protocol to determine the final quantum state and evaluate the cost function (i.e., the quality of the outcome of the optimization). In contrast, direct collocation methods may employ the Schrödinger equation to impose nonlinear constraints between optimization variables at time t and t+1, for example. Since the quantum states are treated as decision variables in direct collocation methods, such methods may have access to them at all times during the optimization. While direct collocation methods may in some examples follow the Mach-Zehnder interferometry paradigm (i.e., split-mirror-recombine operations), they are not restricted to do so and neither will end-to-end optimization necessarily find a solution that is analogous to the Mach-Zehnder interferometry operations.

In some examples, direct collocation methods may be used to perform end-to-end optimization by maximizing the classical Fisher information over the entire interrogation time (i.e., the duration of the shaking protocol). Such examples may include periods of free propagation, which can be substantially longer than the duration of active shaking sequences, and in some cases may be defined before execution of the optimization method. In examples where periods of free propagation are predefined, the optimization method may precompute the quantum propagators for such extended periods of free propagation in order to reduce computational costs during the optimization.

In some examples, the classical Fisher information may depend on the final distribution of momentum states and/or the derivative of the final distribution of momentum states with respect to an optimization parameter determined based at least in part on the one or more optical waves or the estimation parameter (e.g., acceleration). In such examples, the optimization method may be modified so as to augment the quantum state variable with its derivative with respect to the optimization parameter and to solve a Schrödinger-like system of double the dimension of the original quantum state variable. The augmented state vector may thus comprise the original quantum state and the derivative state (i.e., the derivative of the quantum state with respect to the optimization parameter). The dynamics of the derivative state may couple to the dynamics of the original quantum state, thereby resulting in non-unitary dynamics of the derivative state. The dynamics of the augmented state vector may still be given by a Schrödinger-like equation, however with a non-Hermitian Hamiltonian. In contrast to the original quantum state, since the derivative state evolves under non-unitary evolution, it is not required to be normalized at all times.

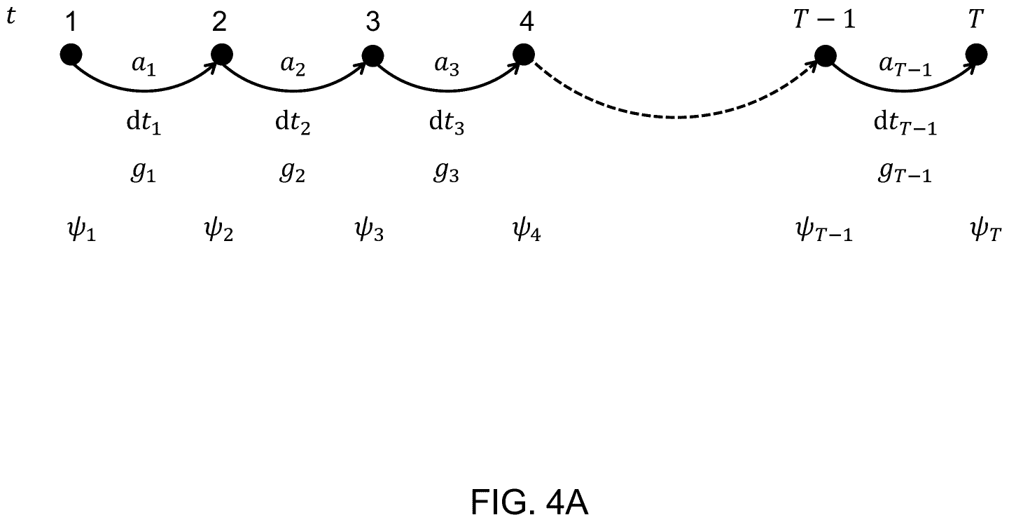

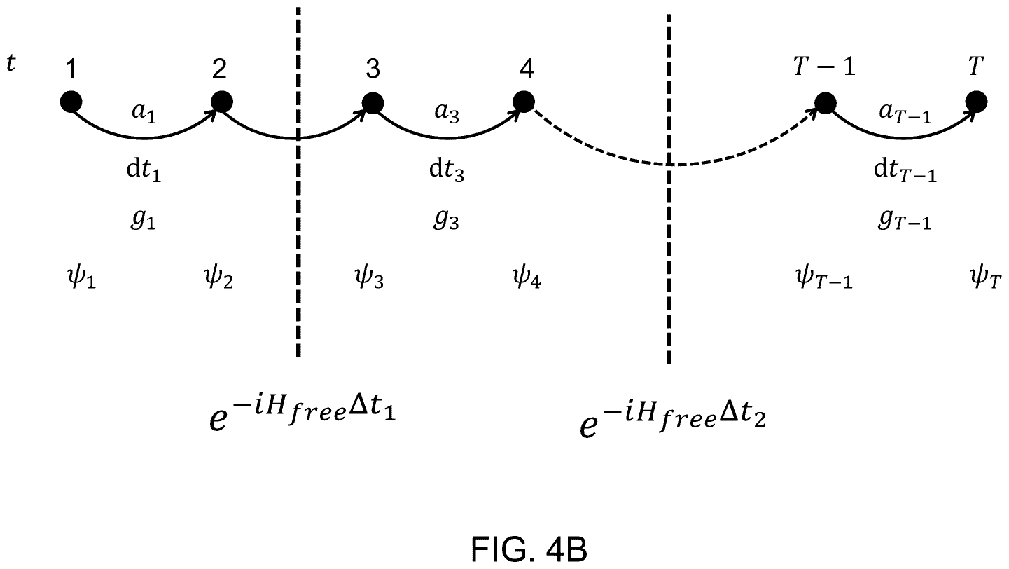

FIG. 4A shows an example PICO method in the context of quantum optimal control. The optimization variable aₜ is a control input at time index t (e.g., comprising one or more control variables). The optimization variable dtₜ is a discrete time step size at index t, which may also be control variables that can be varied in some examples. The optimization variable ψₜ is one or more quantum states at time index t (e.g., state variables). The variable H(aₜ) is a system Hamiltonian at time index t with the control input aₜ. The variable gₜ is a set of nonlinear constraints that connect knot (i.e., collocation) points causally (e.g., a propagator for small time step dtₜ that enforces the laws of physics). The variable gₜ≡g(ψₜ₊₁, ψₜ, aₜ, dtₜ)=ψₜ₊₁−e^{-iH(a}^{ₜ}^{)dt}^{ₜ}ψₜ [symbol] ₀. The matrix exponential can be computed by using the Pade approximation. The variable/is the objective that is sought to be minimized at the final time T. The variable J(ψ₁, ψ₂, . . . ψ_{T}, a₁, a₂, . . . a_{T})=1-| [symbol] ψ_{goal}, ψ_{T} [symbol] |². In this example a special case is shown, such that J is only dependent on the final quantum state ψ_{goal}, which is easily computable as it is directly accessible from the optimization variables. In general, J can be significantly more complex to determine (e.g., a) for sensitively detecting accelerations).

Optimizing shaking protocols comprising laser sequences that are long in duration relative to the discretized time steps used to capture quantum state dynamics can be inefficient due to the increase in computing resources that may be required to simulate a large number of such discrete time steps. In some examples disclosed herein, one or more extended periods of free propagation of the IAMs, comprising laser sequences where the amplitude, frequency, or phase of the laser is not modified, are interspersed between shorter periods of active shaking comprising laser sequences where the amplitude, frequency, or phase of the laser is modified. In some examples, each of the extended periods of free propagation of the IAMs are longer in duration than the sum of the two smallest discretized time steps utilized in the optimization method.

Combining extended periods of free propagation with shorter periods of active shaking can, in some examples, be based on the Mach-Zehnder (MZ) paradigm (e.g., a single beam is split into two beams, each beam evolves independently, is mirrored, and is recombined), however the number of extended periods of free propagation can, in general, vary. In some examples, the start times, durations, and number of the extended periods of free propagation periods are set prior to performing optimization. In other examples, the start times, durations, and number of the extended periods of free propagation periods are determined by the optimization method. The variable start times and durations of extended periods of free propagation may involve recomputing the propagator during execution of the optimization method, resulting in a tradeoff between additional computational overhead and additional flexibility that can lead to better optimization outcomes. In some examples, the corresponding propagators (e.g., the unitary time evolution operators for these extended periods of free propagation periods) can be precomputed and used to replace the e^{-iH(a}^{ₜ}^{)d}^{ₜ} terms in the respective nonlinear constraints gₜ, thereby reducing the computational time and resources needed for the optimization.

FIG. 4B shows an example PICO-based method in the context of quantum optimal control. In this example, the constraint g₂ of FIG. 4A and a constraint imposed some time after t=4 and before t=T−1 are each replaced by an example free propagation unitary U=e₁^{-iH}^{_{free}}^{Δt}^{_{1,2}}, where Δt₁>>dt and Δt₂>>dt. In general, more complex propagators (e.g., time-dependent free evolution) is also possible, and the “environment” of the IAMs may be engineered to specifically implement a desired propagator (e.g., the laser used for the shaking protocol or additional lasers may be used to implement different propagators). In general, the extended periods of free propagation can differ (Δt₁≠Δt₂) or be the same (Δt₁=Δt₂). In this example, dt₁, dt₃ and dt_{T-1} are examples of shorter periods of active shaking, whereas Δt₁ and Δt₂ are examples of extended periods of free propagation. By inserting extended periods of free propagation, the simulation and optimization of shaking protocols comprising shorter active shaking periods can produce better shaking protocols with reduced computational resources.

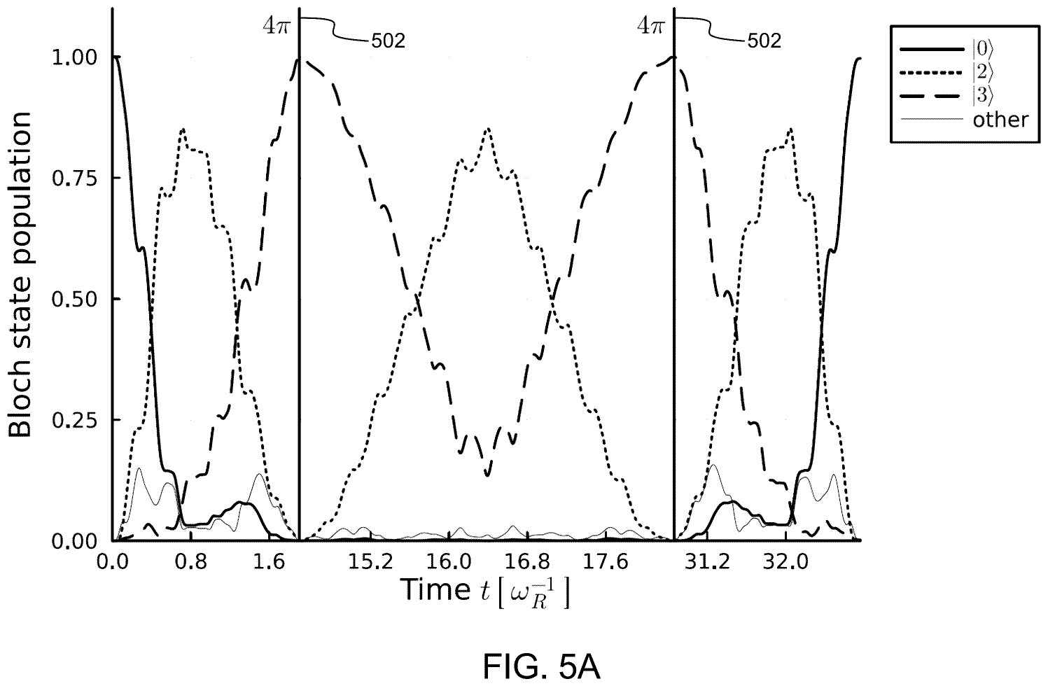

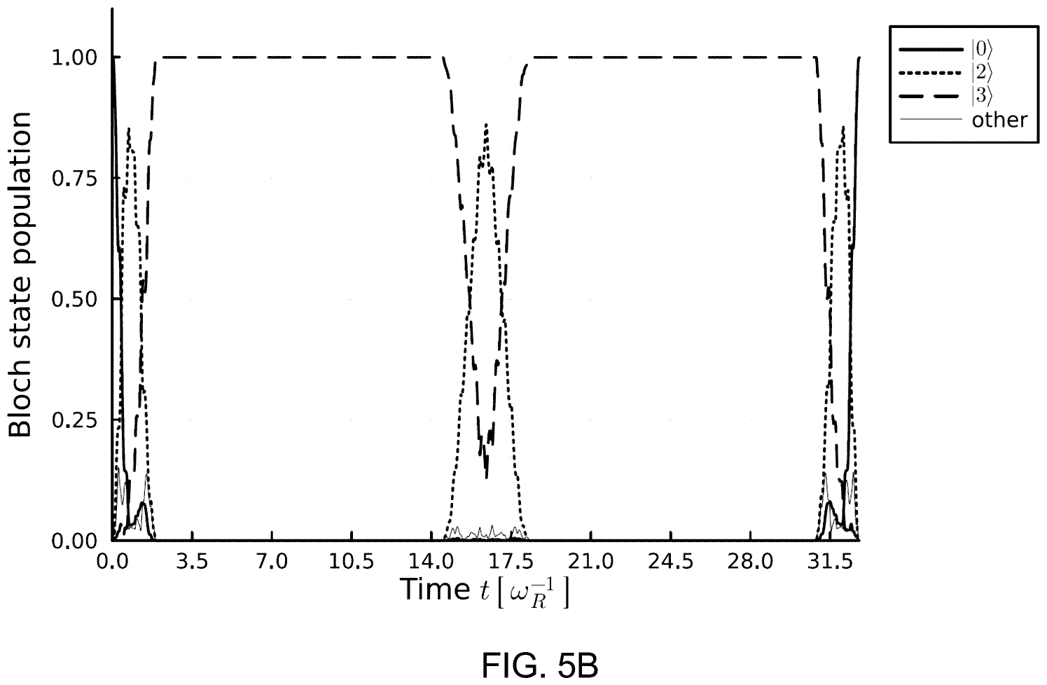

FIG. 5A shows a prophetic plot of the time evolution of Bloch states of IAMs (i.e., the quantum basis states of IAMs trapped in an optical lattice) during execution of an example shaking protocol. In this example, the vertical dashed lines 502 denote the extended periods of free propagation that have a duration equal to 4π×(1/ω_{R}), where

$${ω}_{R} = \frac{{k}_{L}^{2}}{2 m} ,$$

k_{L} is the wavevector of the laser used for shaking, and m is the mass of an individual IAM. The x-axis, representing time, includes jumps in time that correspond to the duration of the respective extended periods of free propagation.

FIG. 5B shows a prophetic plot of the time evolution of Bloch states of IAMs during execution of an example shaking protocol. The extended periods of free propagation that were removed from the x-axis in FIG. 5A are now included to demonstrate the difference in duration that is possible between extended periods of free propagation and shorter periods of active shaking. Performing a “full” simulation and optimization that enforces the extended periods of free propagation enforced (e.g., by fixing the control variables to remain constant over their duration) may be computationally intractable or difficult.

In general, the insertion of extended periods of free propagation can be achieved within a direct collocation method (e.g., a PICO method) that enforces dynamics of the system through constraints, and may be more challenging within other frameworks (e.g., Q-PRONTO). In some examples, the propagators (U) are determined at the start of the optimization method or before it executes, such that the replaced constraints, ψₜ₊₁−Uψₜ=0, are linear constraints with respect to the relevant optimization variables (i.e., the quantum states). The use of linear constraints can, in general, enable a simpler construction of an optimization problem.

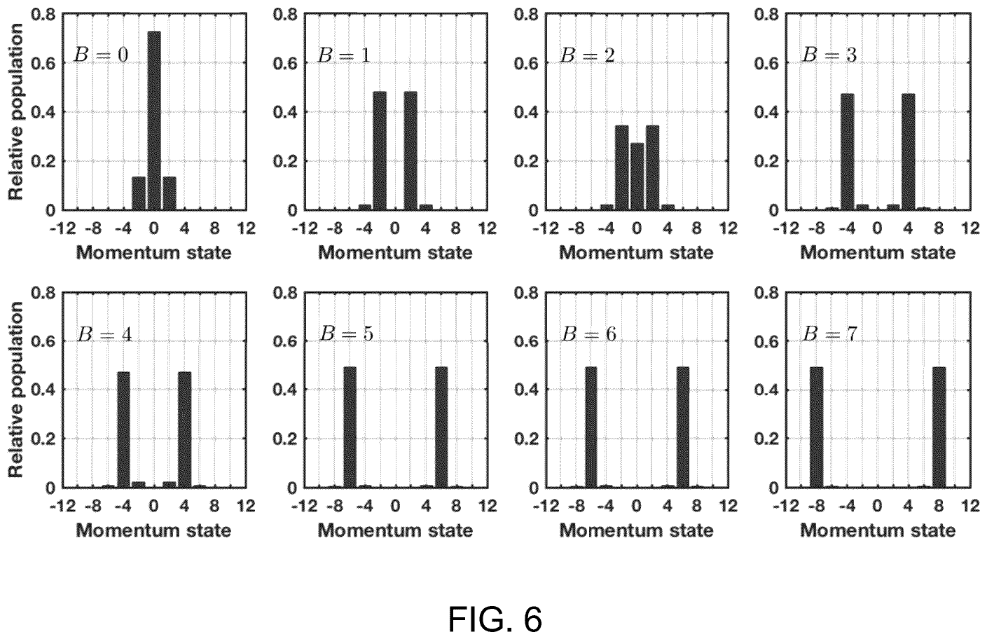

FIG. 6 shows eight prophetic plots of the relative population in each momentum state for eight different Bloch states (B=0, 1, 2, 3, 4, 5, 6, 7). In some examples, the eigenstates of the IAMs during the execution of a shaking protocol are Bloch states, |B [symbol] . Each Bloch state can be characterized by a distribution of momentum states (i.e., the relative quantum state population in each momentum state associated with an IAM). The distribution of momentum states of a single Bloch state is symmetric about zero momentum (e.g., the B=0 Bloch state has equal amounts of quantum population in the +2ℏk momentum state and the −2ℏk momentum state, where k is a wavenumber that depends on the light interacting with the IAMs). If two different Bloch states have similar distributions of momentum, then the two Bloch states have different relative signs (i.e., parity) between equal and opposite momentum states.

In some examples, the sensitivity to a desired parameter of a matter-wave interferometer can be increased by transferring the IAMs from a first Bloch state to a second Bloch state characterized by a larger momentum splitting (i.e., a larger difference between two equal and opposite momentum states that have more population than other momentum states in the distribution of momentum states). In some prophetic example protocols generated by subject matter disclosed herein, transfers to B≥7 Bloch states were achieved. By utilizing PICO methods that incorporate extended periods of free propagation, the sensitivity can be further increased by allowing for longer shaking protocols that can remain computationally feasible to optimize.

In general, optimization methods may require some initialization of parameters (i.e., an initial condition, also referred to as an initial “guess”, for the optimization variables at all times of the shaking protocol) that provide a starting point for the optimization. In some examples (e.g., PICO methods), the initialization parameters can include control variables (e.g., aₜ) and state variables (e.g., quantum states ψₜ). In some examples (e.g., PICO methods), the initial conditions are not required to be consistent with the system dynamics, and in many cases the optimization method can still function and ultimately converge to a feasible solution that is consistent with the system dynamics. In some examples, such as gradient-based optimizers, the initial conditions can have a substantial influence on the optimization and thus affect its performance, convergence, and the quality of the solution (e.g., a local extremum) it finds.

In the context of matter-wave interferometry, designing laser sequences that can generate large momentum splittings of IAMS, where a possibly large number of momentum states can be involved, can involve complex sequences of quantum state transitions. However, some intuition on possibly advantageous sequences of quantum state transitions can be developed. For example, in some cases of an atom “mirror”, a gaseous cloud of IAMs can be split into two gaseous clouds (or components) of IAMs characterized by approximately equal and opposite momentum (±p). The atom mirror can then be designed so as to perform the transformation +p→−p and −p→+p. From a classical viewpoint, such a transformation requires decelerating each cloud to zero momentum, and then accelerating each cloud in a respective direction opposite to its initial propagation direction.

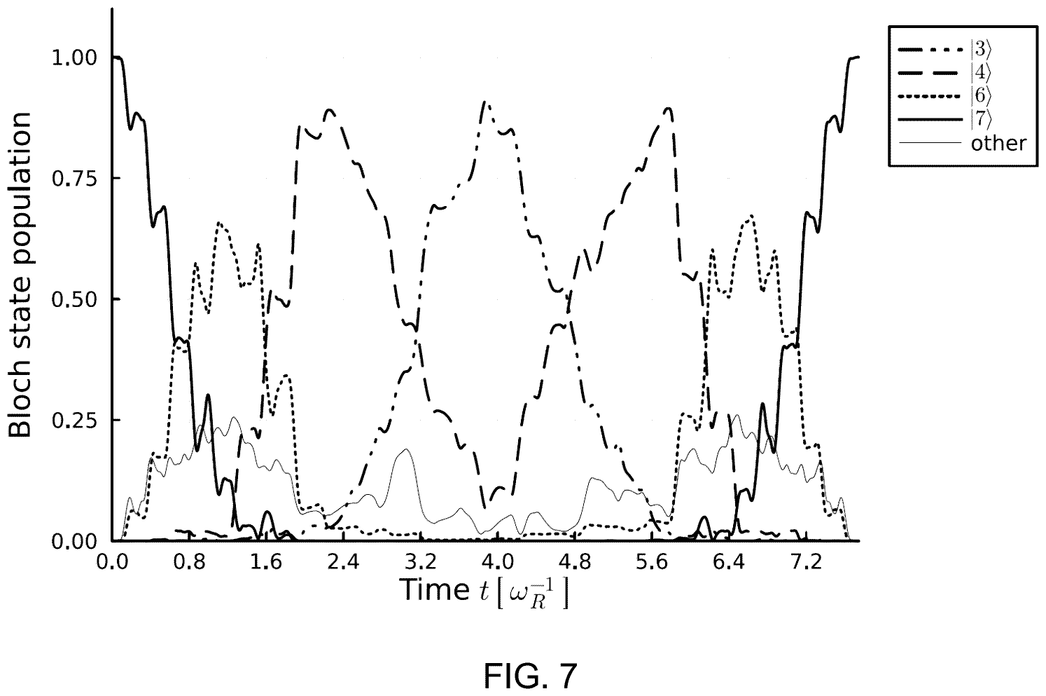

FIG. 7 shows a prophetic plot of the time evolution of Bloch states of IAMs during execution of an example shaking protocol. In this example, the shaking protocol has been chosen so as to perform an atom mirror operation for states characterized by a large momentum splitting. The initial and final quantum states are the same Bloch state, B=7. A non-zero Bloch state implies that the gaseous cloud of IAMs has been split the two components characterized by equal and opposite momenta, and one objective of the atom mirror operation is to negate the momenta of each of the gaseous clouds, in conjunction with other constraints and objectives. In this example, the atom mirror operation is designed to transfer the two gaseous clouds from the B=7 initial state to the B=2 state in the middle of the shaking protocol. The B=2 state is chosen to be populated in the middle of the shaking protocol since it is characterized by a relatively large zero momentum (p=0) quantum state population (e.g., as shown in FIG. 6), which aligns with the aforementioned classical viewpoint.

Setting initial conditions for the optimization variables without regard to desired system dynamics, such as a non-shaken lattice and no change in quantum state populations, can result in failure of the optimizer to find a solution or in poor convergence. In the case of an atom mirror operation, for example, it may be challenging for the optimizer to determine that it may be beneficial to prepare the B=2 state in the middle of the shaking protocol, especially since the B=2 state is substantially different from the initial B=7 state in Hilbert space, under the constraints on the system dynamics. Further adding to such difficulties is the existence of numerous local extrema, combined with the difficulty of the optimizer to traverse infeasible (i.e., unphysical) regions in parameter space when the initial conditions are not physically motivated. Lastly, vanishingly small gradient updates may also lead to the optimizer becoming stuck in infeasible regions or local extrema.

In some examples disclosed herein, the issues associated with some sets of initial conditions can be circumvented by determining initial conditions from combining two or more distinct operations into the initial conditions of a shaking protocol. Each distinct operation may be easier to individually optimize, and the final combination that forms the initial conditions are not necessarily optimal but can then be improved by additional optimization.

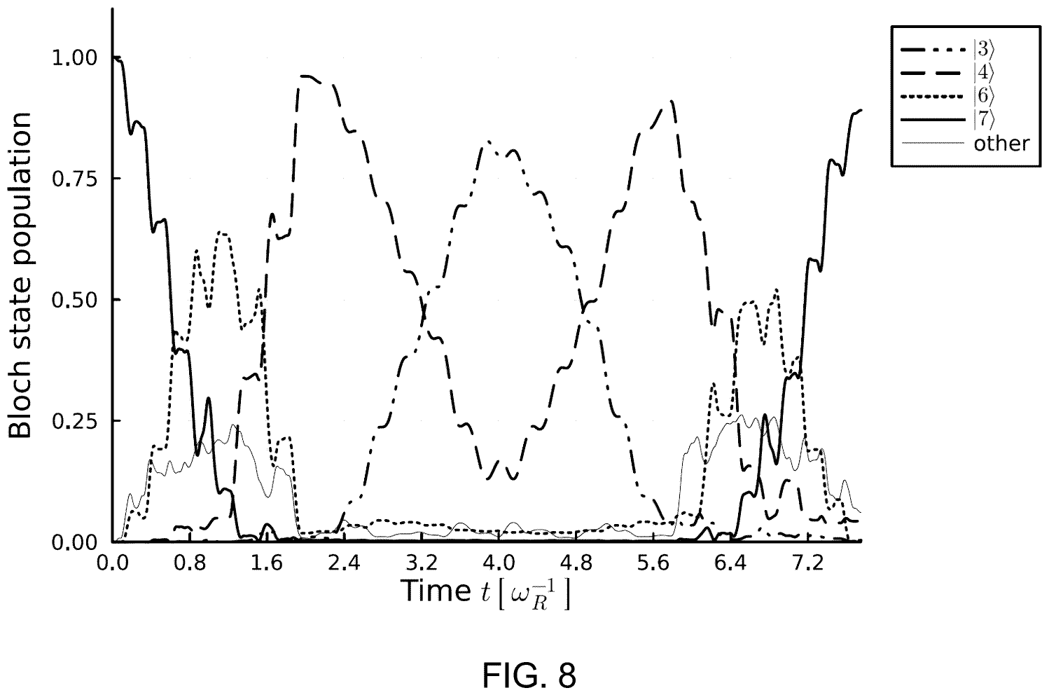

In the case of a B=7 to B=7 atom mirror operation, an example of three distinct operations that can then be combined may be (A) a B=3 to B=3 atom mirror operation which can be determined, for example, from quantum optimal control methods or reinforcement learning, (B) a control operation that transfers the IAMs from the state B=7 to the state B=3, and (C) a time-inverted control operation that transfers the IAMs from the state B=3 to the state B=7. The initial conditions can then be formed by combining the pieces in a time ordering of B-A-C, an example of which is shown in FIG. 8.

FIG. 8 shows a prophetic plot of the time evolution of Bloch states of IAMs during execution of an example shaking protocol. In this example, the shaking protocol has been formed by combining three distinct operations (B-A-C). Each of the three distinct operations have been individually optimized, but not collectively optimized. Collective optimization, that begins with initial conditions corresponding to the optimization used in FIG. 8, was used to generate the shaking protocol shown in FIG. 7.

Combining individually optimized operations may also be applied to optimize other operations (e.g., an atom splitter, which creates two gaseous clouds of IAMs from a single gaseous cloud, or an atom mirror for even larger Bloch states). In some examples, an optimization method may involve first optimizing for smaller Bloch states, which can be a less challenging task, and then reoptimizing for larger Bloch states by modifying the objective function and by potentially increasing the duration of the shaking protocol.

In addition to the aforementioned initial conditions, by utilizing direct collocation methods the user may have access to quantum states of the IAMs (and any other state or control variables), thus allowing the user to impose a constraint/objective on the optimization. To implement an atom mirror operation, such as the one previously described, one example constraint may be of the form

$$“ Population ( B = 2 , t = \frac{T}{2} ) \geq 0.1 ” ,$$

where T is the end time of the shaking protocol. The nature of such a constraint is to, in effect, anticipate or attempt to control the trajectory of the quantum state evolution (i.e., the sequence of quantum states that are populated). Control over the trajectory of state variables may arise in non-quantum applications, such as robotics, since there can often be more waypoints along the trajectory that need to fulfil some requirement. However, in the context of quantum state evolution, such intermediate waypoints may not necessarily be required since it is often only the final result (e.g., a fidelity of the quantum state) that is of concern. Thus, it can seem counterintuitive to impose additional constraints on the quantum state evolution in order to achieve a desired final result. In fact, imposing such constraints can constrain the trajectory in such a way that can be too restrictive and thus lead to poor convergence. However, using the subject matter disclosed herein to develop constraints and individual operations as initial conditions may achieve better results than analogous optimization methods that do not utilize such constraints.

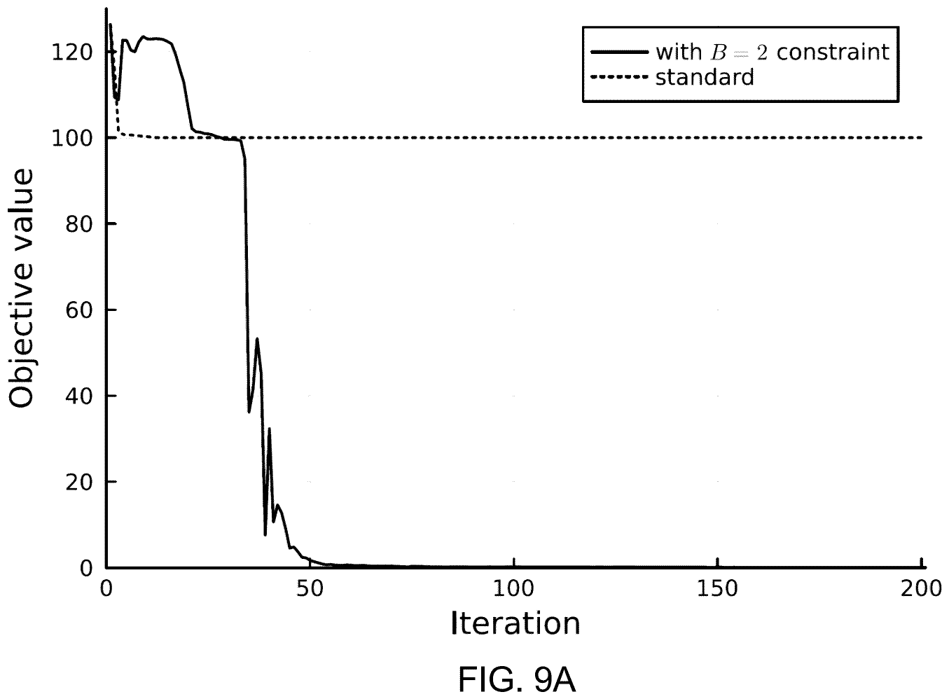

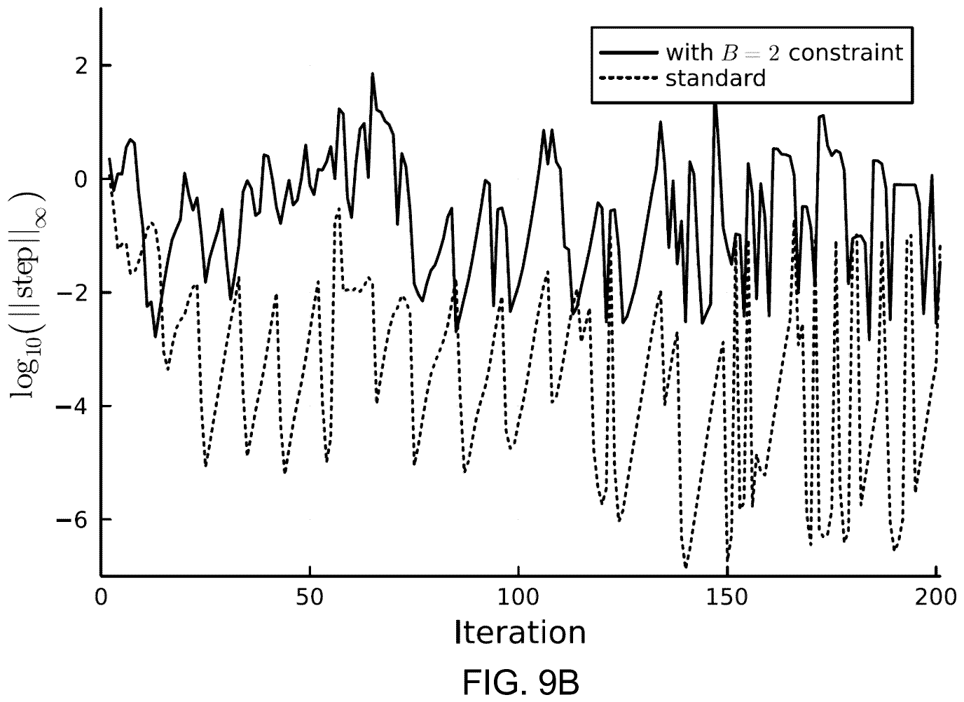

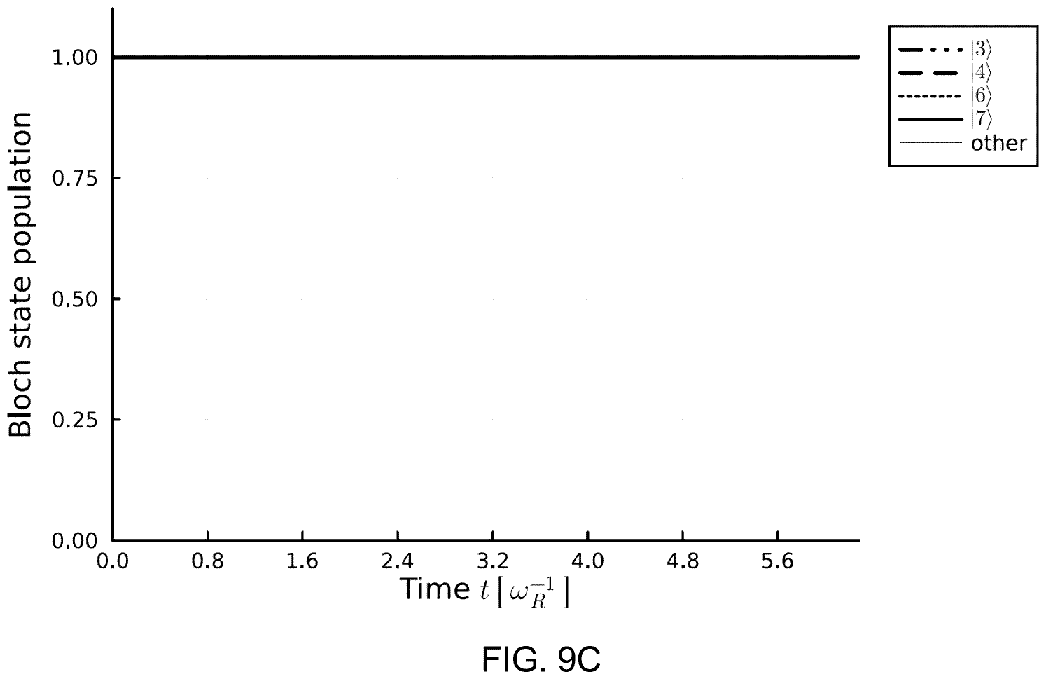

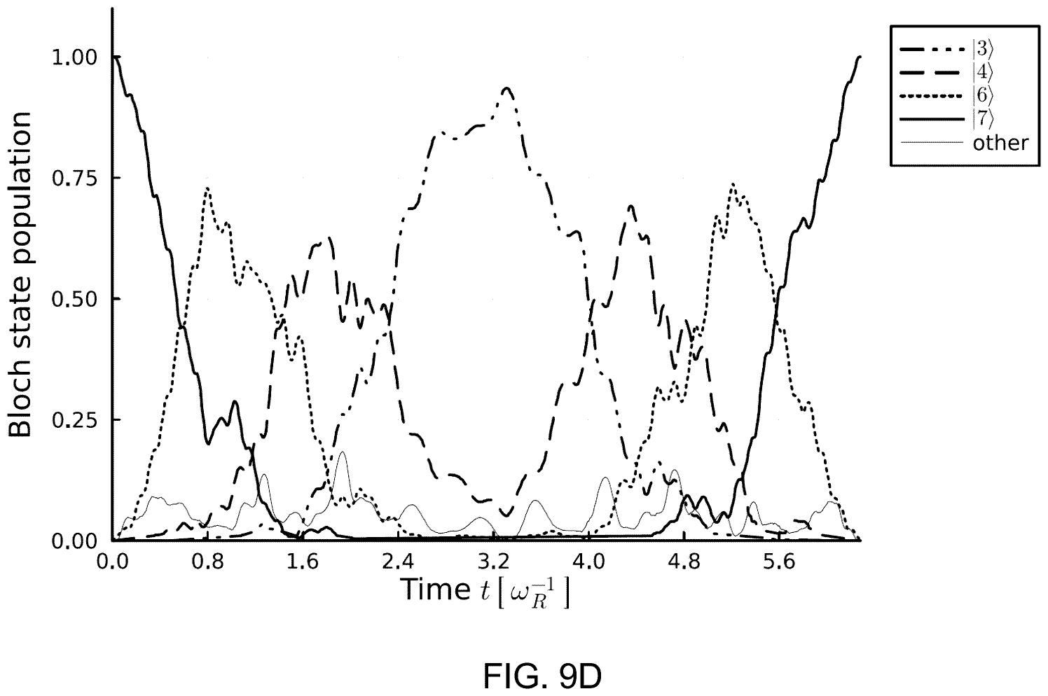

FIG. 9A shows a prophetic plot of a convergence history of an objective value associated with an example objective function for an atom mirror operation, as a function of time, for two different optimization configurations. The initial conditions in both comprise a randomized initial condition for the quantum states and an initial condition for the laser sequence that does not result in shaking (i.e., the amplitude, frequency, and phase of the laser are not modified during the shaking protocol). The “standard” optimization configuration (i.e., with some set of objectives and constraints) and the “with B=2 constraint” optimization configuration, which is the same as the “standard” optimization configuration but with the added constrain

$$“ Population ( B = 2 , t = \frac{T}{2} ) \geq 0.1 ” .$$

The “standard” optimization configuration produces a worse result by plateauing at a larger, more undesirable objective value than the “with B=2 constraint” optimization configuration. In contrast, the optimization method with the extra constraint quickly finds a substantially better solution with a much lower objective value.

FIG. 9B shows a prophetic plot of the norm of the step taken to update the optimization variables in each iteration during an example optimization method for an atom mirror operation, for the same two optimization configurations of FIG. 9A. The “standard” optimization configuration leads to vanishing gradients and thus worse performance, when compared to the “with B=2 constraint” optimization configuration.

FIG. 9C shows a prophetic plot of the time evolution of Bloch states of IAMs during execution of an example shaking protocol generated by the “standard” optimization configuration of FIGS. 9A and 9B. The optimization method is trapped within a local minimum wherein quantum state populations remain static in time.

FIG. 9D shows a prophetic plot of the time evolution of Bloch states of IAMs during execution of an example shaking protocol generated by the “with B=2 constraint” optimization configuration of FIGS. 9A and 9B. The optimization method has converged to a shaking protocol that has quantum state populations that vary over time and can ultimately be used for sensitive parameter estimation.

FIGS. 9A, 9B, 9C, and 9D demonstrate that, even for arbitrary initial conditions (i.e., not substantially motivated by underlying physics), physically motivated constraints or objectives on the trajectory can benefit the performance of direct collocation methods in quantum-based applications. In some examples, such physically motivated constraints or objectives may be combined with initial conditions that are physically motivated (e.g., FIGS. 7 and 8 use such physically motivated initial conditions, but without additional physically motivated constraints or objectives placed during the execution of the optimization method).

In some implementations, any of a variety of other atom operations can be included in addition to, or instead of, an atom splitter and/or an atom mirror. The atom operations can include operations that implement a quantum gate operation, such as a Hadamard gate operation or a Pauli gate operation.

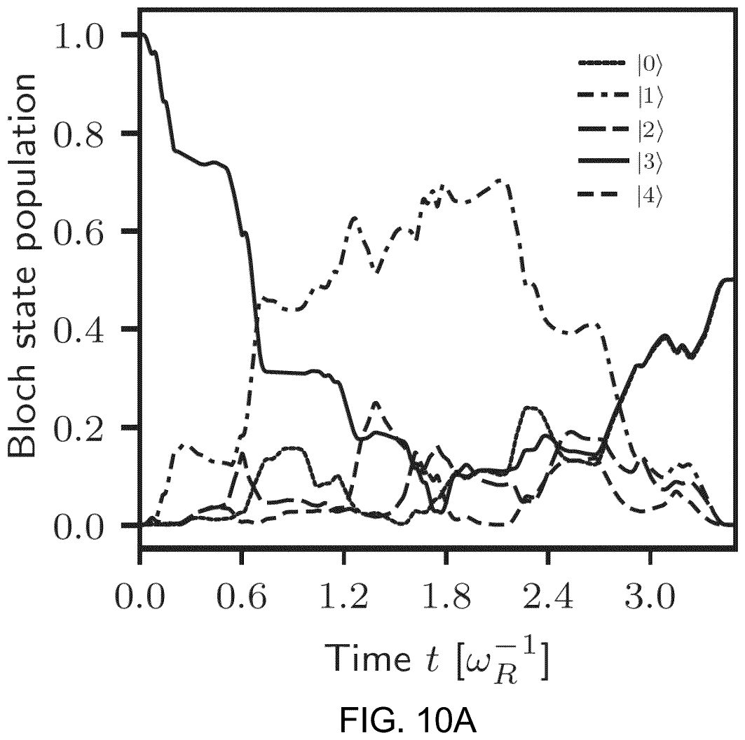

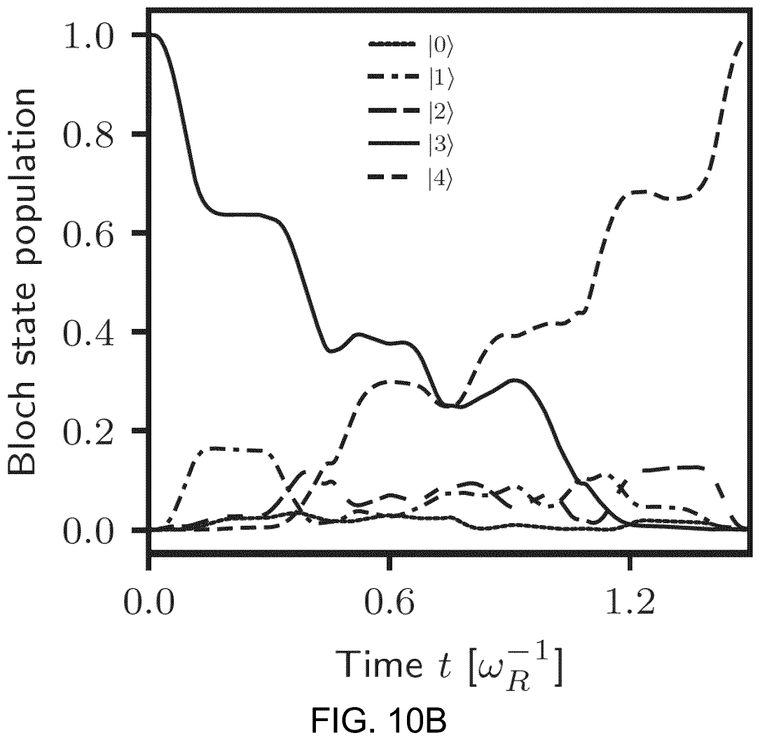

FIG. 10A depicts a prophetic plot of the time evolution of Bloch states of IAMs during execution of a shaking protocol executing a Hadamard operation in the subspace of the B=3 and B=4 Bloch states. The Hadamard operation maps the 3 state onto an equal superposition of the 3 and 4 states.

FIG. 10B depicts a prophetic plot of the time evolution of Bloch states of IAMs during execution of a shaking protocol executing a Pauli-X operation in the subspace of the B=3 and B=4 Block states. The Pauli-X operation exchanges the amplitudes of the 3 and 4 states.

In some examples, the evolution of the quantum system is modeled by the Schrödinger equation applied to a single-particle wavefunction. This is an assumption that ignores correlation and interactions between the atoms in the gaseous cloud of IAMs. In some examples (e.g., with a high density of IAMs), a more accurate description can be provided by the Gross-Pitaevskii equation (GPE), which incorporates a mean-field approximation to account for the effect IAMs have on one another. Utilizing the GPE results in a nonlinear differential equation for the single-particle wavefunction, which is more accurate but also more difficult (e.g., more computationally expensive) to solve than the Schrödinger equation. Thus, some examples of PICO methods disclosed herein include these more general, nonlinear formulations by modifying the constraints on the dynamics of the quantum state evolution. In such examples, instead of connecting quantum states at different moments in time via the matrix exponential e^{-iHdt}, a more complex constraint that is nonlinear with respect to the quantum state optimization variables can be utilized.

Without intending to be bound by theory, the following description can demonstrate theoretical aspects relevant to certain implementations.

In some implementations, a Hamiltonian without acceleration can be:

$$H ( t ) = \frac{{\hat{p}}^{2}}{2 m} - \frac{{V}_{0}}{2} cos ( 2 {k}_{L} \hat{x} + φ ( t ) ) , \qquad ( 1 )$$

such that the Schrödinger equation (SE) in position space can be written as

$$i \dot{ψ} ( x , t ) = - \frac{1}{2 m} \frac{{\partial }^{2} ψ ( x , t )}{\partial {x}^{2}} - \frac{{V}_{0}}{2} cos ( 2 {k}_{L} \hat{x} + φ ( t ) ) ψ ( x , t ) . \qquad ( 2 )$$

Transforming into momentum space,

$$\tilde{ψ} ( p , t ) = \frac{1}{\sqrt{2 π}} \int ψ ( x , t ) {e}^{- ipx} dx , \qquad ( 3 )$$

the following can be obtained:

$$\begin{matrix}i {ψ}^{{.}_{∼}} ( p , t ) = \frac{{\hat{p}}^{2}}{2 m} \tilde{ψ} ( p , t ) - \frac{{V}_{0}}{4} ( {e}^{i φ ( t )} \tilde{ψ} ( p - 2 {k}_{L} ) + {e}^{- i φ ( t )} \tilde{ψ} ( p + 2 {k}_{L} ) & ( 4 ) \\ = \{ \frac{{\hat{p}}^{2}}{2 m} - \frac{{V}_{0}}{4} ( {e}^{i φ ( t )} {b}_{2 {k}_{L}} + {e}^{- i φ ( t )} {b}_{{2}_{{K}_{L}}}^{†} ) \} \tilde{ψ} ( p , t ) & ( 5 )\end{matrix}$$

Here, b₂ₖ_{_{L}} is the translation operation that decreases the momentum by 2k_{L}. Thus, the momentum can only change by multiples of 2k_{L} and can defined as p=p₀+2nk_{L} with n∈ [symbol] . An effectively countably infinite dimensional Hilbert space can be considered such that the quasimomentum can be p₀=0. The Brillouin zone basis {|n [symbol] } and the operators can be defined:

$$\hat{n} \vert n 〉 \qquad ( 6 )$$

$$\hat{b} \vert n 〉 = \vert n - 1 〉 \qquad ( 7 )$$

$${\hat{b}}^{†} \vert n 〉 = \vert n + 1 〉 \qquad ( 8 )$$

The tildes on the quantum state can be dropped while considering the system in momentum space unless otherwise noted. Then:

$$i \vert \dot{ψ} ( x ) 〉 = H ( t ) \vert ψ ( t ) 〉 \qquad ( 9 )$$

$$H ( t ) = \frac{{k}_{L}^{2}}{2 m} 4 {\hat{n}}^{2} - \frac{{V}_{0}}{4} ( {e}^{i φ ( t )} \hat{b} + {e}^{- i φ ( t )} {\hat{b}}^{†} ) \qquad ( 10 )$$

$$\frac{H ( t )}{{ω}_{r}} = 4 {\hat{n}}^{2} - \frac{V}{4} ( {e}^{i φ ( t )} \hat{b} + {e}^{- i φ ( t )} {\hat{b}}^{†} ) \qquad ( 11 )$$

### Here,

$${ω}_{r} = \frac{{k}_{L}^{2}}{2 m}$$

is the lattice recoil energy/frequency and V can be defined as V=V₀/ωᵣ. The RHS of equation (11) is the Hamiltonian in recoil units and these units can be implemented henceforth.

In some implementations, a Hamiltonian with acceleration can be:

$$H ( t ) = \frac{{\hat{p}}^{2}}{2 m} - \frac{{V}_{0}}{2} cos ( 2 {k}_{L} \hat{x} + φ ( t ) ) - F ( t ) \hat{x} . \qquad ( 12 )$$

The transformation into momentum space is linear (FT) and the lattice potential can be ignored in the following discussion and the free particle can be examined:

$$H ( t ) = \frac{{\hat{p}}^{2}}{2 m} - F ( t ) \hat{x} . \qquad ( 13 )$$

“Free” here refers to an optical potential that may be time-dependent but is position-independent, e.g., linear potentials with no trapping. The SE in momentum space can be written:

$$i \dot{ψ} ( p , t ) = ( \frac{{p}^{2}}{2 m} - iF ( t ) \frac{\partial }{\partial p} ) ψ ( p , t ) . \qquad ( 14 )$$

Here, p denotes the total momentum of the particle. From classical mechanics, an evolution of the momentum similar to \dot{P}(t)=F(t) can be expected, thus a variable transformation can be performed:

$$\tilde{p} = p - P ( t ) \qquad ( 15 )$$

$$\tilde{t} = t . \qquad ( 16 )$$

The partial derivatives can then be rewritten:

$$\frac{\partial }{\partial p} = \frac{\partial \tilde{p}}{\partial p} \frac{\partial }{\partial \tilde{p}} + \frac{\partial \tilde{t}}{\partial p} \frac{\partial }{\partial \tilde{t}} = \frac{\partial }{\partial \tilde{p}} \qquad ( 17 )$$

$$\frac{\partial }{\partial t} = \frac{\partial \tilde{p}}{\partial t} \frac{\partial }{\partial \tilde{p}} + \frac{\partial \tilde{t}}{\partial t} \frac{\partial }{\partial \tilde{t}} = - \dot{P} ( \tilde{t} ) \frac{\partial }{\partial \tilde{p}} + \frac{\partial }{\partial \tilde{t}} = - F ( \tilde{t} ) \frac{\partial }{\partial \tilde{p}} + \frac{\partial }{\partial \tilde{t}} . \qquad ( 18 )$$

The SE for a free particle with time-dependent force can be obtained:

$$i ( - F ( \tilde{t} ) \frac{\partial }{\partial \tilde{p}} + \frac{\partial }{\partial \tilde{t}} ) ψ ( \tilde{p} + P ( \tilde{t} ) , \tilde{t} ) = ( \frac{{( \tilde{p} + P ( \tilde{t} ) )}^{2}}{2 m} - iF ( \tilde{t} ) \frac{\partial }{\partial \tilde{p}} ) ψ ( \tilde{p} + P ( \tilde{t} ) , \tilde{t} ) \qquad ( 19 )$$

$$i \frac{\partial }{\partial \tilde{t}} ψ ( \tilde{p} + P ( \tilde{t} ) , \tilde{t} ) = \frac{{( \tilde{p} + P ( \tilde{t} ) )}^{2}}{2 m} ψ ( \tilde{p} + P ( \tilde{t} ) , \tilde{t} ) \qquad ( 20 )$$

$$i \frac{\partial }{\partial t} ϕ ( \tilde{p} , t ) = \frac{{( \tilde{p} + P ( t ) )}^{2}}{2 m} ϕ ( \tilde{p} , t ) \qquad ( 21 )$$

In the last step, \tilde{t}→t using equation (16), and the new wavefunction ψ(\tilde{p}+P(t), t)=ϕ(\tilde{p},t) was introduced. However, this relation is only a formal step and ψ→ϕ can be relabeled in order to stick with ψ as the quantum state. \tilde{p} can be understood as the momentum deviation from the classical momentum P(t) which is fully determined by the force trajectory F(t). The initial condition is P(0)=0.

Turning to the lattice again, it can act on the momentum states:

$${b}_{2 {k}_{L}} : \{ \tilde{p} + P ( t ) \to \tilde{p} + P ( t ) - 2 {k}_{L} \} ⇒ \{ \tilde{p} \to \tilde{p} - 2 {k}_{L} \} \qquad ( 22 )$$

$${b}_{2 {k}_{L}}^{†} : \{ \tilde{p} + P ( t ) \to \tilde{p} + P ( t ) + 2 {k}_{L} \} ⇒ \{ \tilde{p} \to \tilde{p} + 2 {k}_{L} \} \qquad ( 23 )$$

Thus, \tilde{p} becomes the discretized momentum shift \tilde{p}=2nk_{L}+\tilde{p}₀ and because of this analogy the tildes will be dropped henceforth. The full SE including the lattice in SI units reads:

$$i \frac{\partial }{\partial t} \vert ψ ( t ) 〉 = H ( t ) \vert ψ ( t ) 〉 \qquad ( 24 )$$

$$\begin{matrix}H ( t ) = \frac{{( 2 \hat{n} {k}_{L} + P ( t ) )}^{2}}{2 m} - \frac{{V}_{0}}{4} ( {e}^{i φ ( t )} \hat{b} + {e}^{- i φ ( t )} {\hat{b}}^{†} ) & ( 25 ) \\ = 4 {ω}_{r} {\hat{n}}^{2} + 2 {k}_{L} \hat{n} \frac{P ( t )}{2 m} + \frac{{P ( t )}^{2}}{2 m} - \frac{{V}_{0}}{4} ( {e}^{i φ ( t )} \hat{b} + {e}^{- i φ ( t )} {\hat{b}}^{†} ) & ( 26 ) \\ ≅ 4 {ω}_{r} {\hat{n}}^{2} + 2 {k}_{L} \hat{n} \frac{P ( t )}{2 m} - \frac{{V}_{0}}{4} ( {e}^{i φ ( t )} \hat{b} + {e}^{- i φ ( t )} {\hat{b}}^{†} ) & ( 27 )\end{matrix}$$

In the last step, the classical kinetic term P(t)²/2m is dropped because it only changes the global phase of the quantum state |ψ(t) [symbol] .

F(t)=ma=const., which results in P(t)=mat such that the Hamiltonian is:

$$H ( t ) = 4 {ω}_{r} {\hat{n}}^{2} + 2 {k}_{L} a \hat{n} t - \frac{{V}_{0}}{4} ( {e}^{i φ ( t )} \hat{b} + {e}^{- i φ ( t )} {\hat{b}}^{†} ) \qquad ( 28 )$$

Units can be chosen such that:

| variable | unit |
|---|---|
| energy/frequency H, V | ωᵣ |
| time t | ωᵣ⁻¹ |
| distance x | (2k_{L})⁻¹ |
| acceleration a~\ddot{x} | (2k_{L})⁻¹ωᵣ². |

The final Hamiltonian can be obtained:

$$H ( t ) = 4 {\hat{n}}^{2} + a \hat{n} t - \frac{V}{4} ( {e}^{i φ ( t )} \hat{b} + {e}^{- i φ ( t )} {\hat{b}}^{†} ) . \qquad ( 29 )$$

In some implementations, the Hamiltonian can be of the form

$$H ( t ) = {H}_{0} + {\sum }_{j} {γ}_{j} ( t ) {H}_{j} , \qquad ( 30 )$$

where H₀ is the drift Hamiltonian and γⱼ are the control drives that couple to the control Hamiltonians Hⱼ. Equation (29) is not in this form and can be rewritten

$$H ( t ) = 4 {\hat{n}}^{2} + a \hat{n} t - \frac{V}{4} ( I ( t ) ( \hat{b} + {\hat{b}}^{†} ) + i Q ( t ) ( \hat{b} - {\hat{b}}^{†} ) ) \qquad ( 31 )$$

with the controls I(t)=cos(Φ(t)) and Q(t)=sin(φ(t)), where I(t)²+Q(t)²=1. In the presence of acceleration (a≠0), the third control Hamiltonian is H₃(t)=a\hat{n} with associated drive γ₃(t)=t. In some implementations, time-dependent drift terms can be unsupported and this term can be regarded as a drive and an equality constraint can be added for γ₃.

In some implementations, the information/sensitivity can be quantified with respect to acceleration a. The Fisher information can be computed:

$$F ( a ; t ) = {\sum }_{n} \frac{1}{P ( n \vert a ; t )} {( \frac{\partial P ( n \vert a ; t )}{\partial a} )}^{2} \qquad ( 32 )$$

Here, P(n|a;t)=| [symbol] (n|ψ(t) [symbol] |² is the population in a specific BZ |n [symbol] at a time t when acceleration a is present. In some implementations, the final time, i.e. t=T can be of interest. In some implementations, F can be computed using the derivative:

$$\begin{matrix}\frac{\partial P ( n \vert a ; t )}{\partial a} & = & {\partial }_{a} ( 〈 n \vert ψ ( t ) 〉 ) ( 〈 ψ ( t ) \vert n 〉 ) & ( 33 ) \\ & = & 〈 n \vert {\partial }_{a} ψ ( t ) 〉 〈 ψ ( t ) \vert n 〉 + h . c . & ( 34 ) \\ & = & 2 R e \{ 〈 n \vert {\partial }_{a} ψ ( t ) 〉 〈 ψ ( t ) \vert n 〉 \} & ( 35 )\end{matrix}$$

The derivative of the quantum state with respect to the acceleration can be found. The derivative method can be used in the context of robustness to compute the dynamics of the derivative state:

$$i {\partial }_{t} \vert {\partial }_{a} ψ ( t ) 〉 = ( {\partial }_{a} H ( t ) ) \vert ψ ( t ) 〉 + H ( t ) \vert {\partial }_{a} ψ ( t ) 〉 \qquad ( 36 )$$

The dynamics of the derivative state can couple to the dynamics of the normal state and can lead to non-unitary dynamics of the derivative state. The dynamics of the augmented statevector |ψ (t) [symbol] can be given by a Schrödinger-like equation with a non-Hermitian Hamiltonian H(t):

$$i {\partial }_{t} \vert \underline{ψ} ( t ) 〉 = \underline{H} ( t ) \vert \underline{ψ} ( t ) 〉 , \qquad ( 37 )$$

$$i {\partial }_{t} ( \begin{matrix}\vert ψ ( t ) 〉 \\ \vert {\partial }_{a} ψ ( t ) 〉\end{matrix} ) = ( \begin{matrix}H ( t ) & 0 \\ {\partial }_{a} ψ ( t & H ( t )\end{matrix} ) ( \begin{matrix}\vert ψ ( t ) 〉 \\ \vert {\partial }_{a} ψ ( t ) 〉\end{matrix} ) . \qquad ( 38 )$$

This Hamiltonian can be solved with tools that do not run Hermiticity checks.

In this case, the Hamiltonian derivative is ∂ₐH(t)=\hat{n}t as demonstrated by equation (29). By computing the evolution of the augmented system, the Fisher information F(a; t) can be computed directly from the augmented state |ψ(t) [symbol] .

While normalizing the normal state such that | [symbol] n|ψ(t) [symbol] |²=1 can be necessary, normalizing the derivative state can not be necessary due to the non-unitary evolution. Typically, the initial condition for the derivative state can be |∂ₐψ(t) [symbol] =0.

Referring back to equation 38, ∂ₐH(t)=\hat{n}t can grow linearly in time and can have a greater influence on BZ states with larger |n|, suggesting that the norm of |∂ₐψ(t) [symbol] can grow faster when high BZ states have larger weight in |ψ(t) [symbol] . Thus, exciting into high BZ states can be desirable and, in some simulations, the states can be more susceptible to accelerations.

Referring back to chosen units and using ℏ=1, the following relations can elucidate the determination of the chosen units:

$$recoil energy in 2 π \cdot Hz : {E}_{R} = {ω}_{R} = \frac{{k}_{L}^{2}}{2 m} \qquad ( 39 )$$

$$recoil frequency in Hz : {v}_{R} = \frac{{ω}_{R}}{2 π} \qquad ( 40 )$$

$$recoil time in s : {T}_{R} = {v}_{R}^{- 1} \qquad ( 41 )$$

$$lattice spacing in m : d = \frac{π}{{k}_{L}} \qquad ( 42 )$$

The units can be

$$time : t [ s ] = \tilde{t} [ {ω}_{R}^{- 1} ] \cdot {ω}_{R}^{- 1} \qquad ( 43 )$$

$$energy : H [ 2 π \cdot Hz ] = \tilde{H} [ {ω}_{R} ] \cdot {ω}_{R} \qquad ( 44 )$$

$$distance : x [ m ] = \tilde{x} [ d ] \cdot d \qquad ( 45 )$$

$$acceleration : x [ {ms}^{- 2} ] ∼ \frac{{d}^{2} x}{{dt}^{2}} = \frac{{d}^{2} \tilde{x}}{d {\tilde{t}}^{2}} \cdot d {ω}_{R}^{2} ∼ \tilde{a} [ d {ω}_{R}^{2} ] \cdot d {ω}_{R}^{2} \qquad ( 46 )$$

The implemented Hamiltonian (equation (31)) in full detail reads:

$$H ( t ) = 4 {\tilde{n}}^{2} + 2 π \tilde{a} \hat{n} \tilde{t} - \frac{\tilde{V}}{4} ( I ( \tilde{t} ) ( \hat{b} + {\hat{b}}^{†} ) + i Q ( \tilde{t} ) ( \hat{b} - {\hat{b}}^{†} ) ) \qquad ( 47 )$$

For a sine oscillation period of T=100φ_{R}⁻¹, the oscillation frequency is v=0.1ψ_{R} and the angular frequency is ω=2π·0.1ω_{R}.

In the new units, \tilde{t}=1 corresponds to t=ω_{R}⁻¹=(2π)⁻¹T_{R}⁻¹, which means that it represents (2π)⁻¹ of one recoil oscillation and \tilde{t}=2π represents a full oscillation. As an example, if \tilde{t}=15.47, the corresponding recoil oscillations are 15.47/2π≈2.46.

In some implementations, direct collocation can be used to discover shaking sequences for shaken lattice sensing protocols. In the case of a spinless, non-interacting Bose-Einstein condensate (BEC), the equation of motion can be the Schrödinger equation ∂ₜψ=−i H₀ψ for a single particle in a shaken lattice, with Hamiltonian

$${H}_{0} = \frac{{p}^{2}}{2 m} - \frac{{V}_{0}}{4} ( {e}^{i ϕ ( t )} \hat{b} + {e}^{- i ϕ ( t )} {\hat{b}}^{†} ) , \qquad ( 48 )$$

where p is a plane-wave momentum, m is the mass of an atom, V₀ is the lattice depth, ϕ(t) is a time-dependent phase from the shaking sequence, and b=τₚ|p [symbol] [symbol] p+2k_{L}| is a momentum shift operator defined in terms of the lattice wavenumber k_{L}. The noninteracting Hamiltonian factorizes into uncoupled sectors indexed by a quasimomentum k∈(−k_{L}, k_{L}), for which p=k+2k_{L}n and b=τ_{k,n}|k, n [symbol] [symbol] k, n+1| with Brillouin zone index n∈ [symbol] .

Real-space collisional interactions of an ultracold atomic gas can take the form:

$${H}_{int} = {U}_{0} \int d x {ρ ( x )}^{2} \qquad ( 49 )$$

where U₀=4πaᵢₙₜ/m is an interaction strength determined by the s-wave scattering length aᵢₙₜ, and ρ(x)=Ψ(x)^{†}Ψ(x) is the atom density aₜ position x, expressed in terms of the field operator Ψ. Fourier-transforming the field operators as

$$Ψ ( x ) = \frac{1}{\sqrt{V}} \int d k \overline{Ψ} ( k ) {e}^{i k x} ,$$

where V=∫dx is the spatial volume of the experiment, e.g., the number of grid points in a lattice field simulation) yields:

$$\begin{matrix}{H}_{int} & = & \begin{matrix}\frac{{U}_{0}}{{V}^{2}} \int d x d {p}_{1} d {p}_{2} d {p}_{3} {dp}_{4} \\ \tilde{Ψ} ( {p}_{1} ) \tilde{Ψ} ( {p}_{2} ) \tilde{Ψ} ( {p}_{3} ) \tilde{Ψ} ( {p}_{4} ) {e}^{- i x ( {p}_{1} - {p}_{2} + {p}_{3} - {p}_{4} )}\end{matrix} & ( 50 ) \\ & = & \frac{{U}_{0}}{V} \int d p d qdr \tilde{Ψ} ( q - r ) \tilde{Ψ} ( q ) \tilde{Ψ} ( p + r ) \tilde{Ψ} ( p ) & ( 51 )\end{matrix}$$

If the momenta is discretized, a mean-field treatment of momentum-hopping factors leads to the state-dependent single-particle Hamiltonian

$${H}_{int}^{M F} = U {\sum }_{r} 〈 {S}_{r}^{†} 〉 {S}_{r} , {S}_{r} = {\sum }_{p} \vert p + r 〉 〈 p \vert \qquad ( 52 )$$

where U=2NU₀/V is the mean-field momentum-space interaction strength, N is the number of atoms, and [symbol] Sᵣ^{†} [symbol] = [symbol] ψ|Sᵣ^{†}ψ [symbol] is the expectation value of Sᵣ^{†} with respect to the single-particle wavefunction |ψ [symbol] .

In some implementations, direct collocation can treat equations of motion as a constraint on the states {ψₙ}ₙ at discrete times tₙ=Σ_{m<n} τₘ where τₘ is the time interval between tₘ and tₘ₊₁.

For Schrödinger equations of motion ∂ₜψ= [symbol] ψ with generator [symbol] =−iH₀ proportional to the noninteracting Hamiltonian H₀, the dynamic constraints for direct collocation can be written

$${ψ}_{n + 1} = {e}^{{τ}_{n} ℒ} {ψ}_{n} , \qquad ( 53 )$$

where the generator [symbol] can be tentatively assumed to be piecewise constant. To avoid an expensive calculation of [symbol] , the exponential function can be replaced by its order-(k, l) Padé approximant:

$${e}^{z} \approx \frac{{P}_{k} ( z )}{{Q}_{l} ( z )} , \qquad ( 54 )$$

where Pₖ and Qₗ are, respectively, polynomials of degree K and l. In some cases, the order-(2,2) Padé approximant can be used such that:

$${P}_{2} ( z ) = 1 + \frac{1}{2} z + \frac{1}{12} {z}^{2} , {Q}_{2} ( z ) = 1 - \frac{1}{2} z + \frac{1}{12} {z}^{2} , \qquad ( 55 )$$

For brevity, the subscripts k and l can be omitted, leaving the choice of order arbitrary. The dynamical constraint for direct collocation can then be:

$$Q ( {τ}_{n} ℒ ) {ψ}_{n + 1} - P ( {τ}_{n} ℒ ) {ψ}_{n} = 0. \qquad ( 56 )$$

The number of the matrix-vector and the scalar-vector products required to enforce this constraint can be reduced by expanding P(z)=Σ_{k≥0}Pₖz^{k} and Q(z)=Σk≥₀qₖz^{k} and collecting terms to write:

$${\sum }_{k \geq 0} {ℒ}^{k} ( {τ}_{n}^{k} {q}_{k} {ψ}_{n + 1} - {τ}_{n}^{k} {p}_{k} {ψ}_{n} ) = 0. \qquad ( 57 )$$

In some implementations, for numerical stability, rescaling ( [symbol] , τₙ)→(τ [symbol] , δₙ) with δₙ=τₙ/τ˜1 can be useful.

When including mean-field interactions, the equations of motion for the condensate wavefunction can take the form:

$${\partial }_{t} ψ = ℒψ + ( ψ ) , \qquad ( 58 )$$

where [symbol] =−iH₀ is a linear operator proportional to the non-interacting Hamiltonian H₀ and [symbol] is a nonlinear function. A simple strategy for discretizing this equation of motion is to make a first-order approximation in the time interval τₙ:

$${ψ}_{n + 1} = {ψ}_{n} + {τ}_{n} {\partial }_{t} {ψ}_{n} + O ( {τ}_{n}^{2} ) = ( 1 + {τ}_{n} ℒ ) {ψ}_{n} + {τ}_{n} 𝒩 ( {ψ}_{n} ) + O ( {τ}_{n}^{2} ) . \qquad ( 59 )$$

This approximation can be coarse and can yield numerical errors. Another strategy can start with the Volterra integral solution in Eq. 58:

$$ψ ( t ) = {e}^{{τ}_{n} ℒ} ψ ( 0 ) + {\int }_{0}^{t} d s {e}^{( t - s ) ℒ} 𝒩 ( ψ ( t - s ) ) . \qquad ( 60 )$$

The approximation [symbol] (ψ(t−s))≈N(ψ(0)) can lead to the solution

$$ψ ( t ) = {e}^{t ℒ} ψ ( 0 ) + t {φ}_{1} ( t ℒ ) 𝒩 ( ψ ( 0 ) ) , {φ}_{1} ( z ) = \frac{{e}^{z} - 1}{z} , \qquad ( 61 )$$

which can be thought of as exact with respect to the linearity [symbol] , and first-order with respect to the nonlinearity [symbol] . This solution can correspond to the discrete-time relation:

$${ψ}_{n + 1} = {e}^{{τ}_{n} ℒ} {ψ}_{n} + {τ}_{n} {φ}_{1} ( {τ}_{n} ℒ ) 𝒩 ( {ψ}_{n} ) \qquad ( 62 )$$

which is known as the exponential Euler method for solving a nonlinear differential equation. In terms of Padé approximants for the exponential function, a corresponding constraint for direct collocation can be:

$$Q ( {τ}_{n} ℒ ) {ψ}_{n + 1} - P ( {τ}_{n} ℒ ) {ψ}_{n} - {τ}_{n} R ( {τ}_{n} ℒ ) 𝒩 ( {ψ}_{n} ) = 0 , R ( z ) = \frac{P ( z ) - Q ( z )}{z} , \qquad ( 63 )$$

where R(z)=1 for the order-(2,2) Pade approximant in Eq. 55. As before in Eq. 57, the number of floating-point operations required to evaluate Eq. 63 can be reduced by expanding P(z), Q(z), and R(z) in a power series and carefully collecting terms.

A strategy for constructing higher-order approximations to nonlinear equations of motion is to use general-purpose Runge-Kutta (RK) methods. Given the equations of motion of the form ∂ₜψ=f(t, ψ), the general idea is to enforce discrete-time relations of the form:

$${ψ}_{n + 1} = {ψ}_{n} + {τ}_{n} {\sum }_{i = 1}^{s} {b}_{i} {K}_{ni} , \qquad ( 64 )$$

$${K}_{ni} = f ( {t}_{n} + {c}_{i} {τ}_{n} , {ψ}_{n} + {τ}_{n} {\sum }_{j = 1}^{s} {a}_{ij} {K}_{nj} ) ,$$

where bᵢ, cᵢ, aᵢⱼ are scalars. These scalars can be organized into a Butcher tableau:

$$\begin{matrix}c & a \\ & b\end{matrix} = \begin{matrix}{c}_{1} & {a}_{11} & {a}_{12} & … & {a}_{1 s} \\ {c}_{2} & {a}_{21} & {a}_{22} & … & {a}_{2 s} \\ ⋮ & ⋮ & ⋮ & ⋱ & ⋮ \\ {c}_{s} & {a}_{s 1} & {a}_{s 2} & … & {a}_{ss} \\ & {b}_{1} & {b}_{2} & … & {b}_{s}\end{matrix}$$

which defines an order-s RK method. Explicit RK methods have aᵢⱼ=0 for j≥i, which is to say that Kₙᵢ only depends on Kₙⱼ with j<i, which can allow all Kₙᵢ to be computed sequentially for increasing i. Implicit RK methods can require solving a system of equations to obtain values of Kₙᵢ. Explicit methods will be primarily considered in these notes. Rather than using a general-purpose RK method to solve ∂ₜψ=f(t, ψ), improved integration methods based on higher-order approximations of the integral in Eq. 60 can be sought.

Exponential Runge-Kutta (ERK) methods can be obtained using ordinary RK methods to evaluate the integral in Eq. 60 for a single time step. This procedure can lead to discrete-time relations of the form:

$${ψ}_{n + 1} = {e}^{{τ}_{n} ℒ} {ψ}_{n} + {τ}_{n} {\sum }_{i} {b}_{i} ( {τ}_{n} ℒ ) 𝒩 ( {K}_{ni} ) , \qquad ( 65 )$$

$${K}_{ni} = {e}^{{c}_{i} {τ}_{n} ℒ} {ψ}_{n} + {τ}_{n} {\sum }_{j} {a}_{ij} ( {τ}_{n} ℒ ) 𝒩 ( {K}_{nj} ) ,$$

where cᵢ are scalars as before, but now bᵢ and aᵢⱼ are functions. In some examples, the nonlinearity [symbol] can have explicit time dependence such that equation 65 would take [symbol] (Kₙᵢ)→ [symbol] (tₙ+cᵢτₙ, Kₙᵢ). The exponential Euler method in Eq. 62, for example, is the order-1 ERK method with a=0 and b₁=φ₁, defined by the Butcher tableau:

$$\begin{matrix}0 & 0 \\ & {φ}_{1}\end{matrix} .$$

Some higher-order ERK methods, such as the one-parameter families of second-order ERK methods can have Butcher tableaus:

$${T}_{1} ( x ) = \begin{matrix}0 & & \\ x & x {φ}_{1 , 2} & \\ & {φ}_{1} - \frac{1}{x} {φ}_{2} & \frac{1}{x} {φ}_{2}\end{matrix}$$

$$or$$

$${T}_{2} ( x ) = \begin{matrix}0 & & \\ x & x {φ}_{1 , 2} & \\ & ( 1 - \frac{1}{2 x} ) {φ}_{1} & \frac{1}{2 x} {φ}_{1}\end{matrix}$$

where x∈(0,1), and

$${φ}_{k} ( z ) = {\int }_{0}^{1} d θ {e}^{( 1 - θ ) z} \frac{{θ}^{k - 1}}{( k - 1 ) !} , \qquad ( 66 )$$

$${φ}_{k , j} ( z ) = {φ}_{k} ( {c}_{j} z ) ,$$

The functions φₖ for integer k≥0 can alternatively be defined by φ₀=e^{z} and the recurrence relation

$${φ}_{k + 1} ( z ) = \frac{{φ}_{k} ( z ) - {φ}_{k} ( 0 )}{z} . \qquad ( 67 )$$

The second-order ERK method

$${T}_{2} ( \frac{1}{2} )$$

has b₁=0:

$${T}_{2} ( \frac{1}{2} ) = \begin{matrix}0 & & \\ \frac{1}{2} & \frac{1}{2} {φ}_{1 , 2} & \\ & 0 & {φ}_{1}\end{matrix}$$

which can correspond to the discrete time relations

$${ψ}_{n + 1} = {e}^{{τ}_{n} ℒ} {ψ}_{n} + {τ}_{n} {φ}_{1} ( {τ}_{n} ℒ ) 𝒩 ( {ξ}_{n} ) , \qquad ( 68 )$$

$${ξ}_{n} = {e}^{\frac{1}{2} {τ}_{n} ℒ} {ψ}_{n} + \frac{1}{2} {τ}_{n} {φ}_{1} ( \frac{1}{2} {τ}_{n} ℒ ) 𝒩 ( {ψ}_{n} ) .$$

These relations can give the ERK method

$${T}_{2} ( \frac{1}{2} )$$

a simple interpretation: use the order-1 exponential Euler method to compute the approximation ξₙ≈ψ(tₙ+τₙ/2), and then evaluate the integral in Eq. 60 with the midpoint approximation [symbol] (ψ(t−s))≈ [symbol] (ψ(t/2)), which corresponds to replacing [symbol] (ψₙ) in Eq. 62 by [symbol] (ξₙ), thereby arriving aₜ Eq. 68.

In order to use

$${T}_{2} ( \frac{1}{2} )$$

for direct colocation, a consuaint similar to Eq. 63 can be enforced, namely:

$$Q ( {τ}_{n} ℒ ) {ψ}_{n + 1} - P ( {τ}_{n} ℒ ) {ψ}_{n} - {τ}_{n} R ( {τ}_{n} ℒ ) 𝒩 ( {ξ}_{n} ) = 0. \qquad ( 69 )$$

The primary difference with Eq. 63 is that ξₙ needs to be computed, which can be done with the Taylor series:

$${ξ}_{n} = {\sum }_{k \geq 0} {ℒ}^{k} [ {χ}_{n} ( k ) {ψ}_{n} + {χ}_{n} ( k + 1 ) 𝒩 ( {ψ}_{n} ) ] , \qquad ( 70 )$$

$${χ}_{n} = \frac{{τ}_{n}^{k}}{{2}^{k} \times k !} ,$$

Exponential Rosenbrock (ERB) methods are essentially ERK methods applied to a continuous linearization of the equations of motion:

$${\partial }_{t} ψ = f ( t , ψ ) = {ℒ}_{n} ψ + {𝒩}_{n} ( ψ ) , \qquad ( 71 )$$

$${ℒ}_{n} = {∇}_{n}^{τ} f ,$$

$${𝒩}_{n} ( ψ ) = f ( t , ψ ) - {ℒ}_{n} ψ ,$$

where [symbol] is the Jacobian of f at ψₙ, and [symbol] is the remaining nonlinearity. Expanding f(t, ψ)= [symbol] (ψ)+ [symbol] (ψ):

$${ℒ}_{n} = ℒ + {∇}_{n}^{τ} 𝒩 , \qquad ( 72 )$$

$${𝒩}_{n} ( ψ ) = 𝒩 ( ψ ) - ( {∇}_{n}^{τ} 𝒩 ) ( ψ ) ,$$

In the case of the mean-field interaction Hamiltonian in Eq. 52, with slight change of notation:

$${H}_{inf}^{MF} ( ψ ) = U {\sum }_{r} 〈 {ψ}^{r} \vert ψ 〉 \vert {ψ}^{r} 〉 , \qquad ( 73 )$$

$$( {∇}_{n}^{τ} {H}_{inf}^{MF} ) ( ψ ) = U {\sum }_{r} [ ( 〈 {ψ}^{r} \vert {ψ}_{n} 〉 + 〈 {ψ}_{n}^{r} \vert ψ 〉 ) \vert {ψ}_{n}^{r} 〉 + 〈 {ψ}_{n}^{r} \vert {ψ}_{n} 〉 \vert {ψ}^{r} 〉 ] , \qquad ( 74 )$$

where |ψᵣ [symbol] =Sᵣ|ψ [symbol] and |ψₙ^{r} [symbol] =Sᵣ|ψₙ [symbol] .

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus comprising:
a housing configured to provide a low-pressure environment;
a gaseous cloud of ions, atoms, or molecules (IAMs) located in the housing and characterized by a first distribution of momentum states;
a laser configured to emit one or more optical waves;
a memory storing information associated with a set of control signals for controlling at least one of an intensity, frequency, phase, start time, or duration of the one or more optical waves emitted by the laser;
one or more control modules configured to control at least one of the intensity, frequency, phase, start time, or duration of the one or more optical waves emitted by the laser based at least in part on the set of control signals;
at least one photodetector configured to measure a measurement signal associated with a final distribution of momentum states of the IAMs; and
a computing device comprising one or more processors in communication with the photodetector and configured to estimate an estimation parameter associated with the IAMs;
where, during one or more active periods of time over which at least one of an amplitude, frequency, or phase of the one or more optical waves emitted by the laser are modified, the one or more optical waves overlap with and interact with the IAMs and
transfer a first portion of the IAMs from the first distribution of momentum states to a second distribution of momentum states, and
transfer a second portion of the IAMs from the second distribution of momentum states to a third distribution of momentum states;
where the set of control signals are determined based at least in part on at least one of
a constraint determined based at least in part on a set of optical wave parameters associated with the one or more optical waves, and a set of quantum state parameters that are associated with one or more quantum states of the IAMs, where two or more of the quantum state parameters do not satisfy the constraint, or
a partial derivative of one or more quantum states associated with the IAMs, where the partial derivative is with respect to an optimization parameter determined based at least in part on the one or more optical waves or the estimation parameter.

2. The apparatus of claim 1, where the set of control signals are further determined based at least in part on one or more free evolution periods of time over which at least one of the amplitude, frequency, or phase of the one or more optical waves emitted by the laser are not modified.

3. The apparatus of claim 2, where at least one of the one or more free evolution periods of time is at least twice as long in duration as at least one of the one or more active periods of time.

4. The apparatus of claim 2, where the set of control signals are further determined based at least in part on one or more matrices associated with the IAMs during the one or more free evolution periods.

5. The apparatus of claim 4, where the set of quantum state parameters comprises a first quantum state parameter and a second quantum state parameter that are associated with different times during one of the one or more free evolution periods of time and satisfy the constraint.

6. The apparatus of claim 5, where the second quantum state parameter is equal to a multiplication product of (1) the first quantum state parameter and (2) at least one of the one or more matrices.

7. The apparatus of claim 1, where the one or more optical waves form two or more standing waves at the location of the gaseous cloud and the estimation parameter is associated with at least one angular acceleration or at least two different directions of acceleration.

8. The apparatus of claim 1, where each of the first, second, third, and final distributions of momentum states comprises a plurality of population quantities each corresponding to a different respective momentum state of a plurality of momentum states.

9. The apparatus of claim 1, where the set of control signals are further determined based at least in part on classical Fisher information associated with (1) the final distribution of momentum states and (2) the one or more optical waves or the estimation parameter.

10. A method for performing matter-wave interferometry, the method comprising:
determining control signals for one or more optical waves emitted by a laser that interact with a gaseous cloud of ions, atoms, or molecules (IAMs) characterized by a first distribution of momentum states;
controlling at least one of an intensity, frequency, phase, start time, or duration of the one or more optical waves, based at least in part on the determined control signals;
measuring a measurement signal associated with a distribution of momentum states of the gaseous cloud;
estimating an estimation parameter associated with the IAMs based at least in part on the measurement signal;
where, during one or more active periods of time over which at least one of an amplitude, frequency, or phase of the one or more optical waves emitted by the laser are modified, the one or more optical waves overlap with and interact with the IAMs and
transfer a first portion of the IAMs from the first distribution of momentum states to a second distribution of momentum states, and
transfer a second portion of the IAMs from the second distribution of momentum states to a third distribution of momentum states;
where determining the control signals comprises at least one of
determining a constraint based at least in part on a set of optical wave parameters associated with the one or more optical waves, and a set of quantum state parameters that are associated with one or more quantum states of the IAMs, where the quantum state parameters do not satisfy the constraint during candidate active periods of time over which at least one of the amplitude, frequency, or phase of the one or more optical waves emitted by the laser are modified, or
determining a partial derivative of one or more quantum states associated with the IAMs, where the partial derivative is with respect to an optimization parameter determined based at least in part on the one or more optical waves or the estimation parameter.

11. The method of claim 10, where determining the control signals is further based at least in part on one or more free evolution periods of time over which at least one of the amplitude, frequency, or phase of the one or more optical waves emitted by the laser are not modified.

12. The method of claim 11, where at least one of the one or more free evolution periods of time is at least twice as long in duration as at least one of the one or more active periods of time.

13. The method of claim 11, where determining the control signals is further based at least in part on one or more matrices associated with the IAMs during the one or more free evolution periods.

14. The method of claim 13, where the set of quantum state parameters comprises a first quantum state parameter and a second quantum state parameter that are associated with different times during one of the one or more free evolution periods of time and satisfy the constraint.

15. The method of claim 14, where the second quantum state parameter is equal to a multiplication product of (1) the first quantum state parameter and (2) at least one of the one or more matrices.

16. The method of claim 10, where the one or more optical waves form two or more standing waves at the location of the gaseous cloud and the estimation parameter is associated with at least one angular acceleration or at least two different directions of acceleration.

17. The method of claim 10, where each of the first, second, third, and final distributions of momentum states comprises a plurality of population quantities each corresponding to a different respective momentum state of a plurality of momentum states.

18. The method of claim 17, where the second distribution of momentum states comprises a first population quantity of a corresponding momentum state characterized by zero momentum and the third distribution of momentum states comprises a second population quantity of a corresponding momentum state characterized by zero momentum, and where the second population quantity is larger than the first population quantity.

19. The method of claim 18, where during the one or more active periods of time, the one or more optical waves further overlap and interact with the IAMS and transfer a third portion of the IAMs from the third distribution of momentum states to a fourth distribution of momentum states comprising a third population quantity of a corresponding momentum state characterized by zero momentum, where the second population quantity is larger than the third population quantity.

20. The method of claim 10, where determining the control signals is further based at least in part on classical Fisher information associated with (1) the final distribution of momentum states and (2) the one or more optical waves or the estimation parameter.
